(19) United States
(12) Patent Application Publication
(10) Pub. No.: US 2025/0294377 A1
(43) Pub. Date: Sep. 18, 2025

(54) COMMUNICATION DEVICE FOR PERFORMING SENSING BY PROXY

(71) Applicant: GUANGDONG OPPO MOBILE TELECOMMUNICATIONS CORP., LTD., Dongguan (CN)

(72) Inventors: Shiwen HE, Dongguan (CN); Ning GAO, Dongguan (CN); Chaoming LUO, Dongguan (CN); Kangli CAI, Dongguan (CN); Shiyue HUANG, Dongguan (CN)

(21) Appl. No.: 19/222,096

(22) Filed: May 29, 2025

Related U.S. Application Data
(63) Continuation of application No. PCT/CN2022/136379, filed on Dec. 2, 2022.

(51) Int. Cl. H04W 24/02

(52) U.S. Cl. CPC H04W 24/02

(57) ABSTRACT

Provided is a communication device. The communication device is a sensing by proxy initiator supporting a first frequency band and includes: a processor; and a memory, configured to store one or more executable instructions of the processor, wherein the processor is configured to load the one or more executable instructions to cause the communication device to: transmit a SBP Request frame to a sensing by proxy responder, wherein the SBP Request frame is used to request the sensing by proxy responder to perform sensing measurement of a second frequency band in a proxy mode and indicate at least one of a first sensing type or a first sensing range to the sensing by proxy responder; and receive an SBP Response frame from the sensing by proxy responder, wherein the sensing by proxy responder is a device that supports both the first frequency band and the second frequency band.

### CROSS-REFERENCE TO RELATED APPLICATION

This application is a continuation of International Application No. PCT/CN2022/136379, filed Dec. 2, 2022, the entire disclosure of which is incorporated herein by reference.

### TECHNICAL FIELD

Embodiments of the present disclosure relate to the field of wireless local area network (WLAN) sensing, and in particular, relate to a communication for sensing by proxy.

### RELATED ART

WLAN sensing refers to a method and application for sensing a person or an object in an environment by measuring changes in WLAN signals upon scattering and/or reflection by the person or the object. That is, the WLAN sensing measures and senses the surrounding environment based on wireless signals, thereby enabling functions such as detecting indoor intrusions/movements/falls, posture recognition, and establishment of three-dimensional spatial images.

### SUMMARY

Embodiments of the present disclosure provides a communication device for sensing by proxy. The technical solutions are as follows.

According to some embodiments of the present disclosure, a communication device is provided. The method communication device is a sensing by proxy initiator supporting a first frequency band. The communication device includes: a processor; and a memory, configured to store one or more executable instructions of the processor, wherein the processor is configured to load the one or more executable instructions to cause the communication device to: transmit a Sensing by Proxy (SBP) Request frame to a sensing by proxy responder, wherein the SBP Request frame is used to request the sensing by proxy responder to perform sensing measurement of a second frequency band in a proxy mode, and indicate at least one of a first sensing type or a first sensing range to the sensing by proxy responder; and receive an SBP Response frame from the sensing by proxy responder, wherein the sensing by proxy responder is a device that supports both the first frequency band and the second frequency band.

According to some embodiments of the present disclosure, a communication device is provided. The communication device is a sensing by proxy responder supporting a first frequency band and a second frequency band. The communication device includes: a processor; and a memory, configured to store one or more executable instructions of the processor, wherein the processor is configured to load the one or more executable instructions to cause the communication device to: receive an SBP Request frame from a sensing by proxy initiator, wherein the SBP Request frame is used to request the sensing by proxy responder to perform sensing measurement of the second frequency band in a proxy mode; and transmit an SBP Response frame to the sensing by proxy initiator, wherein the SBP Response frame carries third information, the third information carrying information for assisting in parsing a sensing report.

According to some embodiments of the present disclosure, a communication device is provided. The communication device is a sensing by proxy responder supporting a first frequency band and a second frequency band. The communication device includes: a processor; and a memory, configured to store one or more executable instructions of the processor, wherein the processor is configured to load the one or more executable instructions to cause the communication device to: receive an SBP Request frame from a sensing by proxy initiator, wherein the SBP Request frame is used to request the sensing by proxy responder to perform sensing measurement of at least one of a first sensing type or a first sensing range of the second frequency band in a proxy mode; and transmit an SBP Response frame to the sensing by proxy initiator, wherein the sensing by proxy initiator is a device that supports the first frequency band but does not support the second frequency band.

### BRIEF DESCRIPTION OF THE DRAWINGS

For clearer descriptions of the technical solutions in embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a sensing by proxy measurement establishing process provided in the related art;

FIG. 2 is a schematic diagram of a millimeter wave sensing by proxy measurement establishing process provided in the related art;

FIG. 3 is a schematic diagram of a Sub-7 frequency band sensing by proxy measurement establishing process provided in the related art;

FIG. 4 is a schematic diagram of a wireless communication system according to some embodiments of the present disclosure;

FIG. 5 is a flowchart of a method for sensing by proxy according to some embodiments of the present disclosure;

FIG. 6 is a flowchart of a method for sensing by proxy according to some embodiments of the present disclosure;

FIG. 7 is a flowchart of a method for sensing by proxy according to some embodiments of the present disclosure;

FIG. 8 is a diagram of a scenario in which a low-frequency band device requests to perform sensing measurement of a first sensing type of a high-frequency band according to some embodiments of the present disclosure;

FIG. 9 is a flowchart in which a low-frequency band device requests to perform sensing measurement of a first sensing type of a high-frequency band according to some embodiments of the present disclosure;

FIG. 10 is a schematic diagram of a field structure of a DMG SBP Parameters element according to some embodiments of the present disclosure;

FIG. 11 is a schematic diagram of a field structure of a DMG SBP Parameters element according to some embodiments of the present disclosure;

FIG. 12 is a schematic diagram of a field structure of a DMG SBP Parameters Control field according to some embodiments of the present disclosure;

FIG. 13 is a diagram of a scenario in which a low-frequency band device requests to perform sensing measurement of a first sensing range of a high-frequency band according to some embodiments of the present disclosure;

FIG. 14 is a flowchart in which a low-frequency band device requests to perform sensing measurement of a first sensing range of a high-frequency band according to some embodiments of the present disclosure;

FIG. 15 is a schematic diagram of a field structure of a DMG SBP Parameters element according to some embodiments of the present disclosure;

FIG. 16 is a schematic diagram of a field structure of a DMG SBP Parameters Control field according to some embodiments of the present disclosure;

FIG. 17 is a schematic diagram of a field structure of a Target Orientation field according to some embodiments of the present disclosure;

FIG. 18 is a schematic diagram of a scenario in which a first sensing range is calculated according to some embodiments of the present disclosure;

FIG. 19 is a diagram of a scenario in which a low-frequency band device requests to perform sensing measurement of a high-frequency band and parses a sensing report according to some embodiments of the present disclosure;

FIG. 20 is a flowchart in which a low-frequency band device requests to perform sensing measurement of a high-frequency band and parses a sensing report according to some embodiments of the present disclosure;

FIG. 21 is a schematic diagram of a frame structure of an SBP Response frame according to some embodiments of the present disclosure;

FIG. 22 is a diagram of a scenario in which a low-frequency band device parses a sensing report of a high-frequency band according to some embodiments of the present disclosure;

FIG. 23 is a schematic diagram of a frame structure of an SBP Report frame according to some exemplary embodiments of the present disclosure;

FIG. 24 is a structural block diagram of an apparatus for sensing by proxy according to some embodiments of the present disclosure;

FIG. 25 is a structural block diagram of an apparatus for sensing by proxy according to some embodiments of the present disclosure;

FIG. 26 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Reference is made in detail to the embodiments, examples of which are illustrated in the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with some aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” or the like may be used herein to describe various information, such information should not be limited to these terms. These terms are only used to distinguish one type of information from another. For example, first information may also be referred to as second information, and similarly, second information may also be referred to as first information, without departing from the scope of the present disclosure. The word “if”, as used herein, may be interpreted as “in the case that”, “in the case of”, or “in response to determining that”, depending on the context.

### Terms Involved in the Embodiments of the Present Disclosure are Described as Follows.

WLAN sensing: sensing a person or an object in an environment by measuring changes in WLAN signals upon scattering and/or reflection by the person or the object. That is, WLAN sensing measures and senses the surrounding environment based on wireless signals, thereby enabling various functions such as detecting indoor intrusions/movements/falls, posture recognition, and the establishment of three-dimensional spatial images.

Sensing by proxy (SBP): a process of requesting other devices to initiate sensing measurement and acquiring a sensing result. That is, other devices perform sensing measurement in a proxy mode, such that the sensing result is acquired.

WLAN devices participating in the WLAN sensing may include the following roles.

Sensing responder: a device other than a sensing by proxy initiator that participates in sensing measurement.

Sensing initiator: also referred to as a sensing session initiator, a sensing initiating device, or a sensing initiating apparatus. The sensing initiator is a device that initiates sensing measurement and desires to acquire the sensing result.

Sensing by proxy initiator: also referred to as a proxy request device or sensing by proxy request device, which is a device that requests other devices to initiate sensing measurement and desires to acquire the sensing result.

Sensing by proxy responder: also referred to as a sensing proxy station (STA) or sensing by proxy response device, which is a device that responds to a request from the sensing by proxy initiator and initiates sensing measurement.

Sensing participant: in the embodiments of the present disclosure, the sensing participant may include the sensing by proxy initiator participating in sensing measurement, or only include a device other than the sensing by proxy initiator that participates in sensing measurement. That is, in this case, the meaning of the sensing participant is the same as that of the sensing responder.

A WLAN terminal may have one or more roles in one sensing measurement, for example, the sensing by proxy initiator may be only the sensing by proxy initiator, may also be the sensing by proxy responder, or may also be both the sensing by proxy initiator and the sensing by proxy responder.

### SBP Process

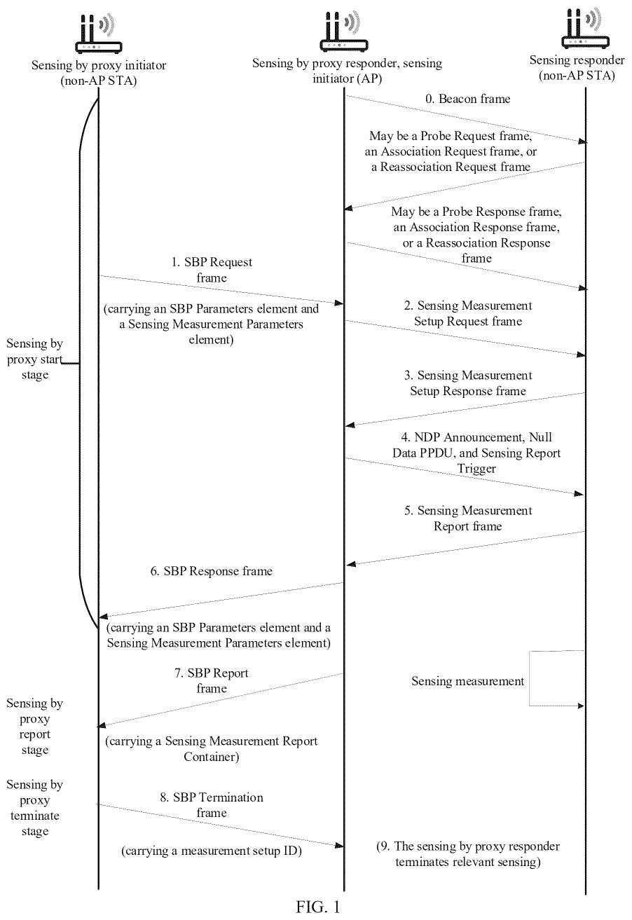

In some embodiments, FIG. 1 is a schematic diagram of a sensing by proxy measurement establishing process provided in the related art.

FIG. 1 illustrates a sensing by proxy initiator, a sensing by proxy responder, a sensing initiator, and a sensing responder. The sensing by proxy responder is configured to respond to an SBP request of the sensing by proxy initiator, and meanwhile acts as the sensing initiator for initiating sensing.

Establishing sensing by proxy measurement includes a sensing by proxy start stage, a sensing by proxy report stage, and a sensing by proxy terminate stage. A sensing by proxy measurement establishing process is briefly described hereinafter.

0. The sensing initiator (AP) broadcasts a Beacon frame, and the sensing responder (non-AP STA) actively transmits a Probe Request frame, an Association Request frame, or a Reassociation Request frame to the sensing initiator; and receives the Probe Request frame, the Association Request frame, or the Reassociation Request frame returned by the sensing initiator for exchanging capability information of the sensing initiator and the sensing responder.

1. The sensing by proxy initiator (non-AP STA) requests the sensing by proxy responder (AP) to establish sensing by proxy measurement (such as WLAN sensing) by transmitting an SBP Request frame to the sensing by proxy responder.

In some embodiments, the SBP Request frame carries at least one of an SBP Parameters element or a Sensing Measurement Parameters element. The SBP Parameters element indicates operation parameters of an SBP process. The Sensing Measurement Parameters element indicates operation parameters of a sensing measurement process.

2. The sensing by proxy responder negotiates with the sensing responder the operation parameters in the sensing measurement process by transmitting a Sensing Measurement Setup Request frame to the sensing responder.

3. The sensing responder indicates confirmation of establishing the sensing measurement by transmitting a Sensing Measurement Setup Response frame to the sensing by proxy responder.

4. The sensing by proxy responder triggers the sensing measurement process by transmitting at least one of an NDP Announcement (NDPA) frame, a Null Data PPDU (NDP) frame, or a Sensing Report Trigger frame to the sensing responder.

5. The sensing responder accepts the sensing measurement process and transmits a sensing measurement report by transmitting a Sensing Measurement Report frame to the sensing by proxy responder.

6. The sensing by proxy responder indicates acceptance of a sensing by proxy task by transmitting an SBP Response frame to the sensing by proxy initiator.

In some embodiments, the SBP Response frame carries at least one of the SBP Parameters element or the Sensing Measurement Parameters element.

Processes 0 to 6 described above belong to the sensing by proxy start stage.

7. The sensing responder completes sensing measurement and reports a sensing measurement result to the sensing by proxy responder. The sensing by proxy responder notifies the sensing measurement result by transmitting an SBP Report frame to the sensing by proxy initiator.

In some embodiments, the SBP Report frame carries a Sensing Measurement Report Container. The Sensing Measurement Report Container is used to carry the sensing measurement report.

Process 7 described above belongs to the sensing by proxy report stage.

8. The sensing by proxy initiator indicates termination of the sensing measurement process by transmitting an SBP Termination frame to the sensing by proxy responder.

In some embodiments, the SBP Termination frame carries a Measurement Setup ID field. The Measurement Setup ID field indicates a sensing measurement process established by the sensing by proxy responder.

9. The sensing by proxy responder terminates relevant sensing.

Processes 8 to 9 described above belong to the sensing by proxy terminate stage.

### SBP Process of High-Frequency Band

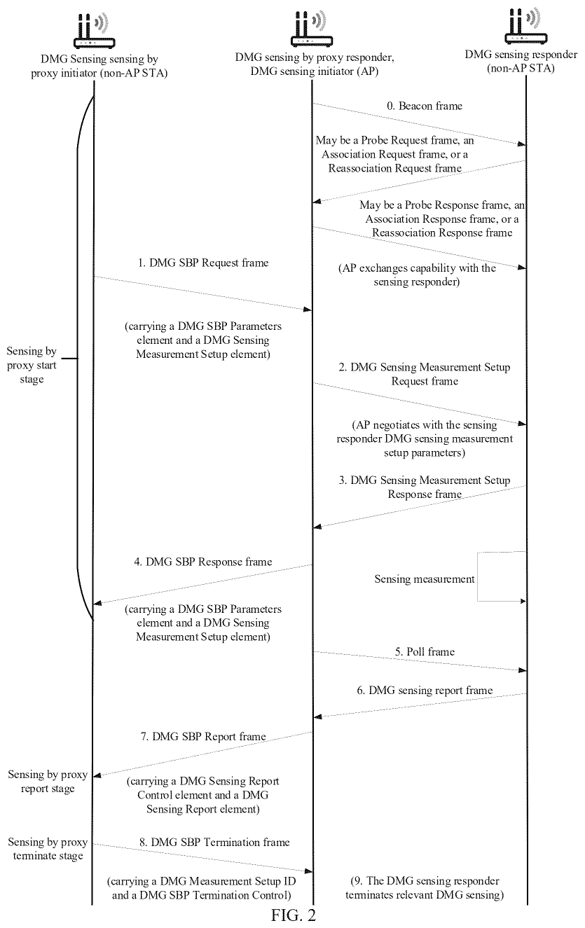

In some embodiments, FIG. 2 is a schematic diagram of a millimeter wave (Directional Multi-Gigabit, DMG) sensing by proxy measurement establishing process provided in the related art.

FIG. 2 illustrates a DMG sensing by proxy initiator, a DMG sensing by proxy responder, a DMG sensing initiator, and a DMG sensing responder. The DMG sensing by proxy responder is configured to respond to an SBP request of the DMG sensing by proxy initiator, and meanwhile acts as the DMG sensing initiator for initiating sensing.

Establishing millimeter wave sensing by proxy measurement includes a sensing by proxy start stage, a sensing by proxy report stage, and a sensing by proxy terminate stage. A DMG sensing by proxy measurement establishing process is briefly described hereinafter.

0. The DMG sensing initiator (AP) broadcasts a Beacon frame, and the DMG sensing responder (non-AP STA) actively transmits a Probe Request frame, an Association Request frame, or a Reassociation Request frame to the DMG sensing initiator, and receives the Probe Request frame, the Association Request frame, or the Reassociation Request frame returned by the DMG sensing initiator for exchanging capability information of the DMG sensing initiator and the DMG sensing responder.

1. The DMG sensing by proxy initiator (non-AP STA) requests the DMG sensing by proxy responder (AP) to establish DMG sensing by proxy measurement (such as DMG sensing) by transmitting a DMG SBP Request frame to the DMG sensing by proxy responder.

In some embodiments, the DMG SBP Request frame carries at least one of a DMG SBP Parameters element or a DMG Sensing Measurement Setup element. The DMG SBP Parameters element indicates operation parameters of an SBP process. The DMG Sensing Measurement Setup element indicates operation parameters of a sensing measurement process.

2. The DMG sensing by proxy responder negotiates with the DMG sensing responder operation parameters in a DMG sensing measurement process by transmitting a DMG Sensing Measurement Setup Request frame to the DMG sensing responder.

3. The DMG sensing responder indicates confirmation of establishing DMG sensing measurement by transmitting a DMG Sensing Measurement Setup Response frame to the DMG sensing by proxy responder.

4. The DMG sensing by proxy responder indicates acceptance of a sensing by proxy task by transmitting a DMG SBP Response frame to the DMG sensing by proxy initiator.

In some embodiments, the DMG SBP Response frame carries at least one of the DMG SBP Parameters element or the DMG Sensing Measurement Setup element.

Processes 0 to 4 described above belong to the sensing by proxy start stage.

5. The DMG sensing responder completes sensing measurement, and the DMG sensing by proxy responder triggers the DMG sensing responder to report a DMG sensing measurement result by transmitting a Poll frame to the DMG sensing responder.

6. The DMG sensing responder reports the DMG sensing measurement result by transmitting a DMG Sensing Report frame to the DMG sensing by proxy responder.

7. The DMG sensing by proxy responder notifies the DMG sensing measurement result by transmitting a DMG SBP Report frame to the DMG sensing by proxy initiator.

In some embodiments, the DMG SBP Report frame carries at least one of a DMG Sensing Report Control element or a DMG Sensing Report element. The DMG Sensing Report Control element and the DMG Sensing Report element indicate the DMG sensing measurement result.

Processes 5 to 7 described above belong to the sensing by proxy report stage.

8. The DMG sensing by proxy initiator indicates termination of the DMG sensing measurement process by transmitting a DMG SBP Termination frame to the DMG sensing by proxy responder.

In some embodiments, the DMG SBP Termination frame carries a DMG Measurement Setup ID field and a DMG SBP Termination Control field. The DMG Measurement Setup ID field indicates a DMG sensing measurement process established by the DMG sensing by proxy responder. The DMG SBP Termination Control field is used to control the termination of the DMG sensing measurement process.

9. The DMG sensing by proxy responder terminates relevant DMG sensing.

Processes 8 to 9 described above belong to the sensing by proxy terminate stage.

### SBP Process of Low-Frequency Band

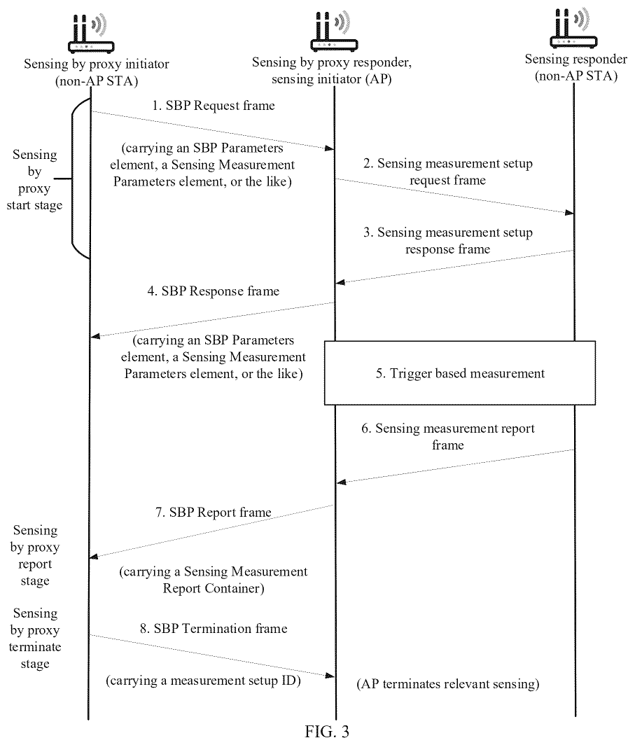

In some embodiments, FIG. 3 is a schematic diagram of a Sub-7 frequency band sensing by proxy measurement establishing process provided in the related art.

FIG. 3 illustrates a sensing by proxy initiator, a sensing by proxy responder, a sensing initiator, and a sensing responder. The sensing by proxy responder is configured to respond to an SBP request of the sensing by proxy initiator, and meanwhile acts as the sensing initiator for initiating sensing.

Establishing Sub-7 frequency band sensing by proxy measurement includes a sensing by proxy start stage, a sensing by proxy report stage, and a sensing by proxy terminate stage. A Sub-7 frequency band sensing by proxy measurement establishing process is briefly described hereinafter.

0. The sensing initiator (AP) broadcasts a Beacon frame, and the sensing responder (non-AP STA) actively transmits a Probe Request frame, an Association Request frame, or a Reassociation Request frame to the sensing initiator; and receives the Probe Request frame, the Association Request frame, or the Reassociation Request frame returned by the sensing initiator for exchanging capability information of the sensing initiator and the sensing responder.

1. The sensing by proxy initiator (non-AP STA) requests the sensing by proxy responder (AP) to establish Sub-7 frequency band sensing by proxy measurement by transmitting an SBP Request frame to the sensing by proxy responder.

In some embodiments, the SBP Request frame carries at least one of an SBP Parameters element or a Sensing Measurement Setup element. The SBP Parameters element indicates operation parameters of an SBP process. The Sensing Measurement Setup element indicates operation parameters of a sensing measurement process.

2. The sensing by proxy responder negotiates with the sensing responder the operation parameters in the sensing measurement process by transmitting a Sensing Measurement Setup Request frame to the sensing responder.

3. The sensing responder indicates confirmation of establishing the sensing measurement by transmitting a Sensing Measurement Setup Response frame to the sensing by proxy responder.

4. The sensing by proxy responder indicates acceptance of a sensing by proxy task by transmitting an SBP Response frame to the sensing by proxy initiator.

In some embodiments, the SBP Response frame carries at least one of the SBP Parameters element or the Sensing Measurement Setup element.

Processes 0 to 4 described above belong to the sensing by proxy start stage.

5. The sensing by proxy responder and the sensing responder complete sensing measurement through a Trigger based (TF) measurement process (TF Sounding).

6. The sensing responder reports a sensing measurement result by transmitting a Sensing Measurement Report frame to the sensing by proxy responder.

7. The sensing by proxy responder notifies the sensing measurement result to the sensing by proxy initiator by transmitting an SBP Report frame to the sensing by proxy initiator.

In some embodiments, the SBP Report frame carries a Sensing Measurement Report Container.

Processes 5 to 7 described above belong to the sensing by proxy report stage.

8. The sensing by proxy initiator indicates termination of the sensing measurement process by transmitting an SBP Termination frame to the sensing by proxy responder, and the sensing by proxy responder terminates relevant sensing.

In some embodiments, the SBP Termination frame carries a Measurement Setup ID field.

Process 8 described above belongs to the sensing by proxy terminate stage.

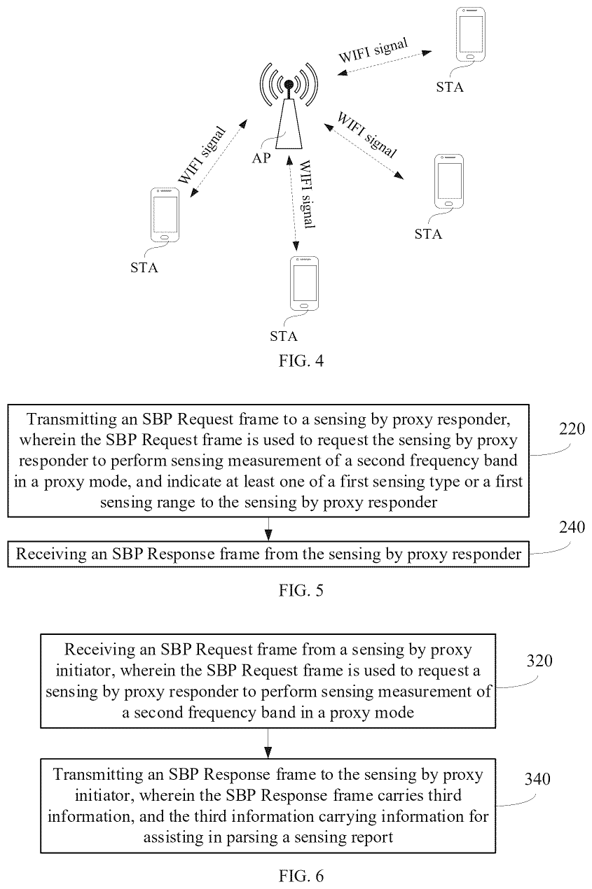

FIG. 4 is a schematic diagram of a wireless communication system according to some embodiments of the present disclosure. As illustrated in FIG. 4, the wireless communication system includes an access point (AP) and stations (STAs).

In some scenarios, the AP is also referred to as an AP STA. That is, the AP is also a type of STA in certain sense. In some scenarios, the STA is also referred to as a non-AP STA.

In some embodiments, STAs include an AP STA and a non-AP STA. The communication within the communication system may be communication between the AP and the non-AP STA, communication between the non-AP STAs, or communication between the STA and a peer STA. The peer STA refers to a device that is in peer-to-peer communication with the STA. For example, the peer STA is an AP or a non-AP STA.

The AP functions as a bridge connecting wired and wireless networks, primarily serving to connect various wireless network clients together and then access the wireless network to the Ethernet. An AP device may be a terminal device (e.g., mobile phone) equipped with a Wi-Fi chip or a network device (e.g., wireless router).

It is understandable that the role of the STA in the communication system is not absolute. For example, in some scenarios, the mobile phone is a non-AP STA in the case that a mobile phone connects to a router, and the mobile phone is an AP in the case that the mobile phone is a hotspot for other mobile phones.

Both the AP and the non-AP STA are devices applicable to the Internet of vehicles, nodes and sensors in the Internet of things (IoT), smart cameras, smart remotes, smart water meters and electricity meters in smart homes, sensors in smart cities, or the like.

In some embodiments, the non-AP STA supports the 802.11be standard. The non-AP STA also supports various current and future WLAN standards of the 802.11 series, such as 802.11ax, 802.11ac, 802.11n, 802.11 g, 802.11b, and 802.11a.

In some embodiments, the AP is a device that supports the 802.11be standard. The AP may also a device that supports various current and future WLAN standards of the 802.11 series, such as the 802.11ax, the 802.11ac, the 802.11n, the 802.11g, the 802.11b, and the 802.11a.

It should be noted that the above protocols are only examples, and the protocols supported by the AP and the STA are not limited to the above protocols.

In the embodiments of the present disclosure, the STA may be a device that supports WLAN/Wi-Fi technology, such as a mobile phone, a pad, a computer, a virtual reality (VR) device, an augmented reality (AR) device, a wireless device in industrial control, a set-top box, a wireless device in self-driving, an in-vehicle communication device, a wireless device in remote medical, a wireless device in smart grids, a wireless device in transportation safety, a wireless device in smart cities, a wireless device in smart homes, a wireless communication chip, an application specific integrated circuit (ASIC), a system on chip (SoC), or the like.

Frequency bands supported by the WLAN technology include but are not limited to low-frequency bands (2.4 GHz, 5 GHz, and 6 GHz) and high-frequency bands (45 GHz and 60 GHz).

One or more links are present between the STA and the AP. In some embodiments, the STA and the AP support multi-frequency-band communication, for example, simultaneous communications at frequency bands of 2.4 GHz, 5 GHZ, 6 GHZ, 45 GHz, and 60 GHz, or simultaneous communications in different channels at a same frequency band (or different frequency bands), such that the communication throughput and/or reliability between devices are improved. Such devices are often referred to as multi-frequency-band devices, multi-link devices (MLDs), multi-link entities, or multi-frequency-band entities. The MLD is an AP device or an STA device. In the case that the MLD is an AP device, the MLD includes one or more APs. In the case that the MLD is an STA device, the MLD includes one or more non-AP STAs.

The MLD including one or more APs is referred to as an AP, and the MLD including one or more non-AP STAs is referred to as a non-AP.

In some embodiments of the present disclosure, the AP includes a plurality of APs, the non-AP includes a plurality of STAs, a plurality of links are formed between the plurality of APs in the AP and the plurality of STAs in the non-AP, and data communication between the plurality of APs in the AP and the corresponding STAs in the non-AP is achieved over the corresponding links.

The AP is a device deployed in a WLAN to provide a wireless communication function for the STA. The STA includes: a user equipment (UE), an access terminal, a subscriber unit, a subscriber station, a mobile station, a mobile console, a remote station, a remote terminal, a mobile device, a wireless communication device, a user agent, a user device, or the like. In some embodiments, the STA is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, or a wearable device, which is not limited in the embodiments of the present disclosure.

In a wireless communication protocol version of the related art, sensing by proxy processes supporting a DMG frequency band and a Sub-7 frequency band are similar in term of procedure. In one aspect, Sub-7 frequency band sensing may provide an indication of large motions and contain rich multipath information. In another aspect, directional transmission of millimeter waves in the DMG frequency band may promote the estimation of the direction, and the large bandwidth of the DMG frequency band provides a high distance resolution, such that fine granularity sensing is achieved. Therefore, for a data drive type algorithm, the robustness and the generalization of a model are expected to be enhanced by fusing sensing measurement of two frequency bands. Based on this, a design solution of cross-frequency band sensing by proxy is provided. For example, a Sub-7 device requests a DMG device to perform sensing of high accuracy, or the DMG device requests the Sub-7 device to perform sensing of a large range. However, the cross-frequency band sensing by proxy has several problems as follows.

1. For the DMG frequency band, a DMG sensing type includes bistatic sensing, multistatic sensing, coordinated bistatic sensing, and coordinated monostatic sensing, and there is no indication of a sensing type of monostatic sensing.

2. In a sensing by proxy start stage or a DMG sensing by proxy start stage of the sensing by proxy process, there is no parameter for specifying the sensing range.

3. In a sensing by proxy report stage, the Sub-7 device and the DMG device cannot parse part of data of a sensing measurement report from the DMG device.

Based on this, the embodiments of the present disclosure provide a design solution for the wireless communication protocol and the cross-frequency band sensing by proxy process in the related art, and the sensing type and the sensing range in the cross-frequency band sensing by proxy are set perfectly.

In some embodiments, requesting cross-frequency bands to perform sensing by proxy according to some embodiments of the present disclosure includes the following scenarios.

1. A low-frequency band device requests to perform sensing by proxy of a high-frequency band, and indicates a desired sensing type.

2. A low-frequency band device requests to perform sensing by proxy of a high-frequency band, and indicates a desired sensing range.

3. A low-frequency band device requests to perform sensing by proxy of a high-frequency band, and acquires some relevant parameters for assisting in parsing the sensing report.

Descriptions are given of sensing flows on the sensing by proxy initiator and the sensing by proxy responder in the embodiments of the present disclosure.

### Sensing by Proxy Initiator

FIG. 5 is a flowchart of a method for sensing by proxy according to some embodiments of the present disclosure. The method which is applicable to a sensing by proxy initiator supporting a first frequency band is described as an example, and the sensing by proxy initiator may be the STA or the AP shown in FIG. 4. The method includes at least part of the following processes.

In process 220, the sensing by proxy initiator transmits an SBP Request frame to a sensing by proxy responder, wherein the SBP Request frame is used to request the sensing by proxy responder to perform sensing measurement of a second frequency band in a proxy mode, and indicate at least one of a first sensing type or a first sensing range to the sensing by proxy responder.

In process 240, the sensing by proxy initiator receives an SBP Response frame from the sensing by proxy responder.

### Sensing by Proxy Responder

FIG. 6 is a flowchart of a method for sensing by proxy according to some embodiments of the present disclosure. The method which is applicable to a sensing by proxy responder supporting both a first frequency band and a second frequency band is described as an example, and the sensing by proxy responder may be the AP or the STA shown in FIG. 4. The method includes at least part of the following processes.

In process 320, the sensing by proxy responder receives an SBP Request frame from a sensing by proxy initiator, wherein the SBP Request frame is used to request the sensing by proxy responder to perform sensing measurement of the second frequency band in a proxy mode.

In process 340, the sensing by proxy responder transmits an SBP Response frame to the sensing by proxy initiator, wherein the SBP Response frame carries third information, the third information carrying information for assisting in parsing a sensing report.

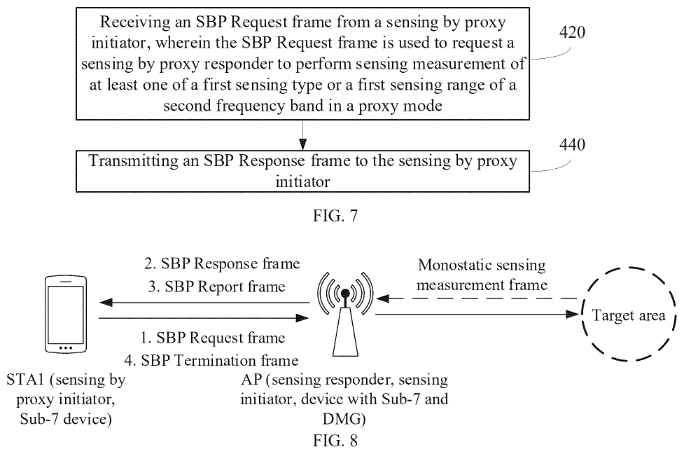

FIG. 7 is a flowchart of a method for sensing by proxy according to some embodiments of the present disclosure. The method which is applicable to a sensing by proxy responder supporting both a first frequency band and a second frequency band is described as an example, and the sensing by proxy responder may be the AP or the STA shown in FIG. 4. The method includes at least part of the following processes.

In process 420, the sensing by proxy responder receives an SBP Request frame from a sensing by proxy initiator, wherein the SBP Request frame is used to request the sensing by proxy responder to perform sensing measurement of at least one of a first sensing type or a first sensing range of the second frequency band in a proxy mode.

In process 440, the sensing by proxy responder transmits an SBP Response frame to the sensing by proxy initiator.

The first sensing type is a specified sensing type indicated by the sensing by proxy initiator over the SBP Request frame. The first sensing range is a specified sensing range indicated by the sensing by proxy initiator over the SBP Request frame.

In some embodiments, the first frequency band is a low-frequency band, such as a Sub-7 frequency band, and the sensing by proxy initiator supporting the first frequency band is a sensing by proxy initiator supporting the Sub-7 band, and also referred to as a Sub-7 device or a low-frequency band device.

In some embodiments, the first frequency band is a high-frequency band, such as a DMG frequency band, a millimeter wave frequency band, a terahertz frequency band, or a visible light frequency band. The present embodiment takes the DMG frequency band as an example, and the sensing by proxy initiator supporting the first frequency band is a sensing by proxy initiator supporting the DMG frequency band, and also referred to as a DMG device or a high-frequency band device.

In some embodiments, the SBP Request frame is used to request the sensing by proxy responder to perform sensing measurement of the second frequency band in a proxy mode.

In some embodiments, the SBP Request frame is used to request the sensing by proxy responder to perform sensing measurement of the first frequency band and the second frequency band in a proxy mode.

In some embodiments, the SBP Request frame further indicates at least one of the first sensing type or the first sensing range to the sensing by proxy responder.

### 1. Design of a Frame Format of the SBP Request Frame

### 1.1 Indication of a First Sensing Type

In some embodiments, the SBP Request frame needs to indicate the desired first sensing type to the sensing by proxy responder, and based on FIGS. 5, 6, and 7, the SBP Request frame needs to carry information related to a sensing type.

The information related to the sensing type may be explicitly indicated by adopting a mode of increasing values to existing information fields in the SBP Request frame; or explicitly indicated by adopting a method of newly added information fields in the SBP Request frame; or synergistically indicated by existing information fields and newly added information fields in the SBP Request frame. An “information field” herein is at least one of a field, an element, or a container.

In some embodiments, the information related to the sensing type is first information, wherein the first information may indicate one sensing type from all sensing types or indicate only one sensing type required.

In some embodiments, the SBP Request frame carries the first information, wherein the first information indicates the first sensing type.

The first sensing type is one of a plurality of sensing types, wherein the plurality of sensing types include monostatic sensing.

In some embodiments, the first information includes at least one of: a Sensing Type field; a Monostatic Sensing field; or at least one subfield of an SBP Parameters element.

### 1.1.1 Indication Mode 1 for the First Sensing Type

In some embodiments, the first information includes the Sensing Type field.

In some embodiments, the first sensing type desired by the sensing by proxy initiator is indicated by a value of the Sensing Type field. Different values of the Sensing Type field correspond to different sensing types. The corresponding relationship between the value of the Sensing Type field and the sensing type includes one or more of the following cases.

In the case where the Sensing Type field takes a first value, the first sensing type is coordinated monostatic sensing.

In the case where the Sensing Type field takes a second value, the first sensing type is coordinated bistatic sensing.

In the case where the Sensing Type field takes a third value, the first sensing type is bistatic sensing.

In the case where the Sensing Type field takes a fourth value, the first sensing type is multistatic sensing.

In the case where the Sensing Type field takes a fifth value, the first sensing type is monostatic sensing.

In some embodiments, in the case where the first frequency band is the Sub-7 frequency band, the first value is set to be 0, the second value is set to be 1, the third value is set to be 2, the fourth value is set to be 3, and the fifth value is set to be 4. That is, in the case that the first frequency band is the Sub-7 frequency band, there are the following cases.

In the case where the Sensing Type field takes a value of 0, the first sensing type is the coordinated monostatic sensing.

In the case where the Sensing Type field takes a value of 1, the first sensing type is the coordinated bistatic sensing.

In the case where the Sensing Type field takes a value of 2, the first sensing type is the bistatic sensing.

In the case where the Sensing Type field takes a value of 3, the first sensing type is the multistatic sensing.

In the case where the Sensing Type field takes a value of 4, the first sensing type is the monostatic sensing.

The first value, the second value, the third value, the fourth value, and the fifth value in the above embodiments are only examples, and specific values may be adjusted or other values may be set based on actual technical needs.

In some embodiments, the Sensing Type field is carried in a Sensing Measurement Setup element corresponding to the second frequency band, wherein the Sensing Measurement Setup element indicates the operation parameters in the sensing measurement process.

In some embodiments, the Sensing Type field is carried in a Sensing Measurement Setup Control field in the Sensing Measurement Setup element corresponding to the second frequency band.

In some embodiments, in the case where the first frequency band is the Sub-7 frequency band, the Sensing Measurement Setup element corresponding to the second frequency band is a DMG Sensing Measurement Setup element.

### 1.1.2 Indication Mode 2 for the First Sensing Type

In some embodiments, the first information includes the Monostatic Sensing field.

In some embodiments, whether the first sensing type desired by the sensing by proxy initiator is the monostatic sensing is indicated by a value of the Monostatic Sensing field.

In a case where the Monostatic Sensing field takes a first value, the first sensing type is not the monostatic sensing.

In a case where the Monostatic Sensing field takes a second value, the first sensing type is the monostatic sensing.

In some embodiments, in the case where the first frequency band is the Sub-7 frequency band, the first value is set to be 0, and the second value is set to be 1. That is, in the case that the first frequency band is the Sub-7 frequency band, there are the following cases.

In a case where the Monostatic Sensing field takes a value of 0, the first sensing type is not the monostatic sensing.

In a case where the Monostatic Sensing field takes a value of 1, the first sensing type is the monostatic sensing.

The first value and the second value in the above embodiments are only examples, and specific values may be adjusted or other values may be set based on actual technical needs.

In some embodiments, in the case where the Monostatic Sensing field takes the first value, and the first sensing type is not the monostatic sensing, the sensing by proxy initiator needs to continue indicating the sensing type. Based on this, the first information further includes the Sensing Type field, and the first sensing type desired by the sensing by proxy initiator is indicated over the Sensing Type field.

In some embodiments, in the case that the Monostatic Sensing field takes the first value, the first sensing type is a sensing type indicated by the value of the Sensing Type field. Furthermore, the first sensing type is indicated by the value of the Sensing Type field.

In some embodiments, the Monostatic Sensing Type field is carried in an SBP Parameters element corresponding to the second frequency band, wherein the SBP Parameters element indicates the operation parameters in the sensing measurement process.

In some embodiments, the Monostatic Sensing Type field is carried in an SBP Parameters Control field in the SBP Parameters element corresponding to the second frequency band.

In some embodiments, in the case where the first frequency band is the Sub-7 frequency band, the SBP Parameters element corresponding to the second frequency band is a DMG SBP Parameters element, and the SBP Parameters Control field is a DMG SBP Parameters Control field.

### 1.1.3 Indication Mode 3 for the First Sensing Type

In some embodiments, the first information includes the Sensing Type field and the at least one subfield of the SBP Parameters element.

In some embodiments, the SBP Parameters element indicates the operation parameters of the sensing by proxy process.

In some embodiments, the first sensing type desired by the sensing by proxy initiator is indicated by a value of the Sensing Type field and a value of the at least one subfield of the SBP Parameters element. The corresponding relationship between a value of the Sensing Type field and the first sensing type includes one or more of the following cases.

In the case where the Sensing Type field takes a first value and the at least one subfield of the SBP Parameters element takes a predetermined value corresponding to the subfield, the first sensing type is the monostatic sensing.

In the case where the Sensing Type field takes a first value and the at least one subfield of the SBP Parameters element does not take a predetermined value corresponding to the subfield, the first sensing type is coordinated monostatic sensing.

In the case where the Sensing Type field takes a second value, the first sensing type is coordinated bistatic sensing.

In the case where the Sensing Type field takes a third value, the first sensing type is bistatic sensing.

In the case where the Sensing Type field takes a fourth value, the first sensing type is multistatic sensing.

In some embodiments, in the case where the first frequency band is the Sub-7 frequency band, the first value is set to be 0, the second value is set to be 1, the third value is set to be 2, the fourth value is set to be 3, and the fifth value is set to be 4. That is, in the case that the first frequency band is the Sub-7 frequency band, there are the following cases.

In the case where the Sensing Type field takes a value of 0 and the at least one subfield of the SBP Parameters element is the predetermined value corresponding to the subfield, the first sensing type is the monostatic sensing.

In the case where the Sensing Type field takes a value of 1 and the at least one subfield of the SBP Parameters element is not the predetermined value corresponding to the subfield, the first sensing type is the coordinated monostatic sensing.

In the case where the Sensing Type field takes a value of 2, the first sensing type is the coordinated bistatic sensing.

In the case where the Sensing Type field takes a value of 3, the first sensing type is the bistatic sensing.

In the case where the Sensing Type field takes a value of 4, the first sensing type is the multistatic sensing.

The first value, the second value, the third value, and the fourth value in the above embodiments are only examples, and specific values may be adjusted or other values may be set based on actual technical needs.

In some embodiments, the at least one subfield of the SBP Parameters element is carried in the SBP Parameters element corresponding to the second frequency band.

In some embodiments, in the case where the first frequency band is the Sub-7 frequency band, the SBP Parameters element corresponding to the second frequency band is the DMG SBP Parameters element, and the DMG SBP Parameters element includes at least one of the following subfields:
DMG SBP Request;
DMG Sensing Responder;
DMG Number of Sensing Responders;
DMG Mandatory Number of Responders;
DMG Number of Preferred responders;
DMG Preferred Responder List;
DMG Mandatory Preferred Responder;
DMG Sensing Responder Addresses; or
DMG Sensing Responder IDs.

In some embodiments, the predetermined value corresponding to the subfield of DMG SBP Request is 1; the predetermined value corresponding to the subfield of DMG Sensing Responder is 1; the predetermined value corresponding to the subfield of DMG Number of Sensing Responders is 4; the predetermined value corresponding to the subfield of DMG Mandatory Number of Responders is 1; the predetermined value corresponding to the subfield of DMG Number of Preferred Responders is 4; the predetermined value corresponding to the subfield of DMG Preferred Responder List is 1; the predetermined value corresponding to the subfield of DMG Mandatory Preferred Responder is 1; the predetermined value corresponding to the subfield of DMG Sensing Responder Addresses is n*6; and the predetermined value corresponding to the subfield of DMG Sensing Responder IDs is n.

The predetermined value in the above embodiments are only examples, and specific values may be adjusted or other values may be set based on actual technical needs.

### 1.2 Indication of the First Sensing Range

In some embodiments, the SBP Request frame needs to indicate the desired first sensing range to the sensing by proxy responder, and based on FIGS. 5, 6, and 7, the SBP Request frame needs to carry information related to a sensing range.

The information related to the sensing range may be explicitly indicated by adopting a mode of increasing values to existing information fields in the SBP Request frame; or explicitly indicated by adopting a method of newly added information fields in the SBP Request frame; or synergistically indicated by existing information fields and newly added information fields in the SBP Request frame. An “information field” herein is at least one of a field, an element, or a container.

In some embodiments, the information related to the sensing range is second information, wherein the second information indicates the first sensing range.

In some embodiments, the SBP Request frame carries the second information, wherein the second information indicates the first sensing range.

In some embodiments, the second information includes at least one of:
a Target Orientation field;
a Location Configuration Information (LCI) field; or
a Peer Orientation field.

In some embodiments, the Target Orientation field indicates location information of a target relative to the sensing by proxy initiator.

In some embodiments, the LCI field indicates location information of the sensing by proxy initiator.

In some embodiments, the Peer Orientation field indicates location information of the sensing by proxy responder that is measured by the sensing by proxy initiator.

In some embodiments, the second field further includes at least one of the following additional fields:
a Target Orientation Present field;
an LCI Present field; or
a Peer Orientation Present field.

In some embodiments, the Target Orientation Present field indicates whether the Target Orientation field is present.

In some embodiments, the LCI Present field indicates whether the LCI field is present.

In some embodiments, the Peer Orientation Present field indicates whether the Peer Orientation field is present.

In some embodiments, whether the Target Orientation field is present is indicated by a value of the Target Orientation Present field.

In some embodiments, whether the LCI field is present is indicated by a value of the LCI Present field.

In some embodiments, whether the Peer Orientation field is present is indicated by a value of the Peer Orientation Present field.

In the case where the Target Orientation Present field takes a first value, the Target Orientation field is not present.

In the case where the Target Orientation Present field takes a second value, the Target Orientation field is present.

In the case where the LCI Present field takes the first value, the LCI field is not present.

In the case where the LCI Present field takes the second value, the LCI field is present.

In the case where the Peer Orientation Present field takes the first value, the Peer Orientation field is not present.

In the case where the Peer Orientation Present field takes the second value, the Peer Orientation field is present.

In some embodiments, the first value described above is set to be 0, and the second value described above is set to be 1.

The first value and the second value in the above embodiments are examples, and specific values may be adjusted or other values may be set based on actual technical needs.

In some embodiments, the Target Orientation field includes at least one of:
a Target Azimuth subfield;
an Azimuth Span subfield;
a Target Elevation subfield;
an Elevation Span subfield;
a Target Range subfield; or
a Range Span subfield.

In some embodiments, the Target Azimuth subfield indicates an azimuth of the target relative to the sensing by proxy initiator.

In some embodiments, the Azimuth Span subfield indicates a span size of the azimuth.

In some embodiments, the Target Elevation subfield indicates an elevation of the target relative to the sensing by proxy initiator.

In some embodiments, the Elevation Span subfield indicates a span size of the elevation.

In some embodiments, the Target Range subfield indicates a range of the target relative to the sensing by proxy initiator.

In some embodiments, the Range Span subfield indicates a span size of the range.

In some embodiments, the Peer Orientation field includes at least one of:
an Azimuth subfield;
an Elevation subfield; or
a Range subfield.

In some embodiments, the Azimuth subfield indicates an azimuth direction of the sensing by proxy responder that is measured by the sensing by proxy initiator.

In some embodiments, the Elevation subfield indicates an elevation direction of the sensing by proxy responder that is measured by the sensing by proxy initiator.

In some embodiments, the Range subfield indicates a range of the sensing by proxy responder that is measured by the sensing by proxy initiator.

In some embodiments, the additional fields described above are carried in the SBP Parameters Control field.

In some embodiments, in the case where the first frequency band is the Sub-7 frequency band, the SBP Parameters Control field is the DMG SBP Parameters Control field.

In some embodiments, the second information is carried in the SBP Parameters element corresponding to the second frequency band.

In some embodiments, in the case where the first frequency band is the Sub-7 frequency band, the SBP Parameters element corresponding to the second frequency band is the DMG SBP Parameters element.

In some embodiments, the sensing by proxy responder is a device that supports both the first frequency band and the second frequency band. Therefore, the sensing by proxy responder can perform sensing measurement of the second frequency band in a proxy mode.

In some embodiments, after the sensing by proxy responder negotiates sensing parameters with other devices, the sensing by proxy responder transmits the SBP Response frame to the sensing by proxy initiator. The sensing by proxy initiator receives the SBP Response frame from the sensing by proxy responder.

In some embodiments, the sensing by proxy responder transmits the SBP Report frame to the sensing by proxy initiator. The sensing by proxy initiator receives the SBP Report frame from the sensing by proxy responder.

### 2. Design of a Frame Format of at Least One of the SBP Response Frame or the SBP Report Frame

In some embodiments, in order to enable the sensing by proxy initiator to better parse the sensing report, the sensing by proxy responder transmits information on assisting in parsing the sensing report to the sensing by proxy initiator over the SBP Response frame.

In some other embodiments, in the case where the SBP Response frame does not carry or partially carries the information on assisting in parsing the sensing report, the sensing by proxy responder transmits the information on assisting in parsing the sensing report to the sensing by proxy initiator over the SBP Report frame.

The information on assisting in parsing the sensing report may be explicitly indicated by adopting a mode of increasing values to existing information fields in at least one of the SBP Response frame or the SBP Report frame; or explicitly indicated by adopting a method of newly added information fields in at least one of the SBP Response frame or the SBP Report frame; or synergistically indicated by existing information fields and newly added information fields in at least one of the SBP Response frame or the SBP Report frame. An “information field” herein is at least one of a field, an element, or a container.

In some embodiments, the information on assisting in parsing the sensing report is third information. The third information may include at least one of information related to beams, or information related to operation parameters in the sensing measurement process. The information related to the beams may include at least one of information related to transmitter beams or information related to receiver beams.

In some embodiments, the third information indicates at least one of:

lists of transmitter beams or receiver beams of N sensing by proxy responders; or

operation parameters of the N sensing by proxy responders in the sensing measurement process.

In some embodiments, in the case where the first frequency band is the Sub-7 frequency band, a Sensing Beam Descriptor element is a DMG Sensing Beam Descriptor element.

In some embodiments, the lists of transmitter beams or receiver beams of the N sensing by proxy responders are carried in N Sensing Beam Descriptor elements, wherein each of the N Sensing Beam Descriptor elements carries the list of receiver beams of one sensing by proxy responder.

In some embodiments, in the case where the first frequency band is the Sub-7 frequency band, the N Sensing Beam Descriptor elements are DMG Sensing Beam Descriptor element 1 to DMG Sensing Beam Descriptor element N.

In some embodiments, DMG Sensing Beam Descriptor element 1 carries the lists of transmitter beams or receiver beams of a first sensing by proxy responder, DMG Sensing Beam Descriptor element 2 carries the lists of transmitter beams or receiver beams of a second sensing by proxy responder, and DMG Sensing Beam Descriptor element N carries the lists of transmitter beams or receiver beams of an N^{th} sensing by proxy responder.

In some embodiments, the operation parameters of the N sensing by proxy responders in the sensing measurement process are carried in N Sensing Measurement Setup elements, wherein each of the N Sensing Measurement Setup elements carries the operation parameters of one sensing by proxy responders in the sensing measurement process.

In some embodiments, in the case where the first frequency band is the Sub-7 frequency band, the N Sensing Measurement Setup elements are DMG Sensing Measurement Setup element 1 to DMG Sensing Measurement Setup element N.

In some embodiments, DMG Sensing Measurement Setup element 1 carries the operation parameters of the first sensing by proxy responder in the sensing measurement process, DMG Sensing Measurement Setup element 2 carries the operation parameters of the second sensing by proxy responder in the sensing measurement process, and DMG Sensing Measurement Setup element N carries the operation parameters of the N-th sensing by proxy responder in the sensing measurement process.

In some embodiments, N is set based on the number of the sensing by proxy responders participating in sensing measurement.

In some embodiments, N is the number of the sensing by proxy responders actually participating in sensing measurement.

### 3. Optional Design of a Frame Format of the SBP Report Frame

In some other embodiments, the sensing by proxy responder transmits additional information on assisting in parsing the sensing report to the sensing by proxy initiator over the SBP Report frame.

The additional information on assisting in parsing the sensing report may be explicitly indicated by adopting a mode of increasing values to existing information fields in the SBP Report frame; or explicitly indicated by adopting a method of newly added information fields in the SBP Report frame; or synergistically indicated by existing information fields and newly added information fields in the SBP Report frame. An “information field” herein is at least one of a field, an element, or a container.

In some embodiments, the additional information on assisting in parsing the sensing report is fourth information. The fourth information may include information related to range, doppler, and beam orientations.

In some embodiments, the SBP Report frame carries the fourth information, wherein the fourth information carries the information for assisting in parsing the sensing report.

In some embodiments, the fourth information includes at least one of:
a Range subfield;
a Doppler subfield;
a Transmitter Beam Orientation subfield; or
a Receiver Beam Orientation subfield.

In some embodiments, the fourth information is carried in a Sensing Image Report element of the second frequency band.

In some embodiments, the fourth information is carried in a Sensing Image Report Data element in the Sensing Image Report element of the second frequency band.

In some embodiments, in the case where the first frequency band is the Sub-7 frequency band, the Sensing Report element of the second frequency band is a DMG Sensing Report element, and the Sensing Image Report Data element is a DMG Sensing Image Report Data element.

It should be noted that each frame and the frame format thereof in the foregoing embodiments may be designed or adjusted based on actual technical needs, and the foregoing embodiments may also be arbitrarily combined, which is not limited in the embodiments of the present disclosure.

In summary, the embodiments of the present disclosure can realize, based on the sensing by proxy responder that supports both the first frequency band and the second frequency band, that the sensing by proxy initiator supporting the first frequency band requests the sensing by proxy responder to perform sensing measurement of the second frequency band in a proxy mode, and meanwhile, the sensing by proxy initiator is further capable of indicating at least one of the first sensing type or the first sensing range to the sensing by proxy responder. By adopting the methods of the embodiments of the present disclosure, the cross-frequency band sensing by proxy can be realized, the application range of sensing by proxy is enlarged, and meanwhile the sensing type and the sensing range in the cross-frequency band sensing by proxy are set perfectly, the sensing efficiency is accelerated, and high-precision sensing for the target is realized. In the case where other high-frequency band devices are not present around, the sensing by proxy responder performs monostatic sensing to acquire the sensing by proxy service. Furthermore, the sensing by proxy initiator can be assisted to better parse the sensing report, such that the flexibility of sensing by proxy is ensured, and the sensing by proxy initiator is capable of fully utilizing sensing measurement results of various devices in the environment.

As an example, a low-frequency band device performing sensing by proxy of a high-frequency band is taken as an example, and several sensing processes involved in the embodiments of the present disclosure are described in detail hereinafter.

### 1. The Low-Frequency Band Device Requests to Perform Sensing Measurement of a First Sensing Type of the High-Frequency Band.

1.1 a Process in which the Low-Frequency Band Device Requests to Perform Sensing Measurement of the First Sensing Type of the High-Frequency Band

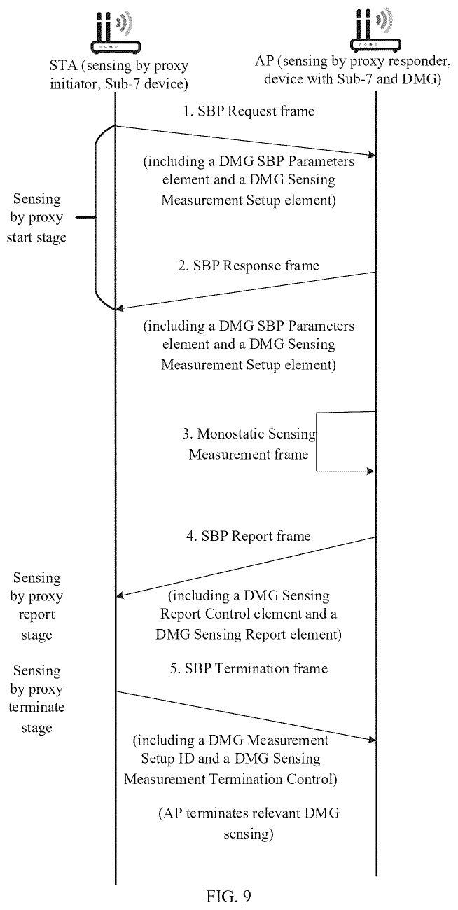

FIG. 8 is a diagram of a scenario in which a low-frequency band device requests to perform sensing measurement of a first sensing type of a high-frequency band according to some embodiments of the present disclosure. FIG. 9 is a flowchart in which a low-frequency band device requests to perform sensing measurement of a first sensing type of a high-frequency band according to some embodiments of the present disclosure.

The first sensing type as monostatic sensing is taken as an example. FIGS. 8 and 9 relate to a sensing by proxy initiator (STA1, a Sub-7 device) and a sensing by proxy responder (AP, a device with both DMG and Sub-7 sensing capabilities), wherein the sensing by proxy responder is used to respond to an SBP request of the sensing by proxy initiator.

Referring to FIGS. 8 and 9, the process in which the low-frequency band device requests to perform sensing measurement of the first sensing type of the high-frequency band is briefly described hereinafter.

In process 1, the sensing by proxy initiator (STA1, the Sub-7 device) initiates a DMG sensing by proxy process by transmitting an SBP Request frame to the sensing by proxy responder (AP).

In some embodiments, the SBP Request frame carries at least one of a DMG SBP Parameters element, or a DMG Sensing Measurement Setup element.

In some embodiments, the sensing by proxy initiator indicates the first sensing type as monostatic sensing over the SBP Request frame.

In process 2, the sensing by proxy responder (AP) indicates acceptance of the sensing by proxy task by transmitting an SBP Response frame to the sensing by proxy initiator (STA1, the Sub-7 device).

In some embodiments, the SBP Response frame carries at least one of the DMG SBP Parameters element, or the DMG Sensing Measurement Setup element.

In process 3, the sensing by proxy responder (AP) completes the DMG sensing measurement process based on the setting in the SBP Request frame, and completes monostatic sensing by transmitting monostatic PPDUs.

In process 4, the sensing by proxy responder (AP) notifies the DMG sensing measurement result by transmitting an SBP Report frame to the sensing by proxy initiator (STA1, the Sub-7 device).

In some embodiments, the SBP Report frame carries at least one of a DMG Sensing Report Control element, or a DMG Sensing Report element.

In process 5, the sensing by proxy initiator (STA1, the Sub-7 device) indicates termination of the relevant DMG sensing by transmitting an SBP Termination frame to the sensing by proxy responder (AP).

In some embodiments, the SBP Termination frame carries at least one of a DMG Measurement Setup ID, or a DMG SBP Termination Control field.

### 1.2 Frame Format of the Low-Frequency Band Device

### 1.2.1 the First Sensing Type is Indicated Based on a DMG Sensing Measurement Setup Element Carried in an SBP Request Frame

The DMG Sensing Measurement Setup element indicates relevant parameters of the DMG sensing measurement setup. A Sensing Type field in a Measurement Setup Control field in the DMG sensing measurement setup may indicate the sensing type.

In some embodiments, different values of the Sensing Type field correspond to different sensing types. The sensing type includes one of coordinated monostatic sensing, coordinated bistatic sensing, bistatic sensing, multistatic sensing, or monostatic sensing. The corresponding relationship between a value of the Sensing Type field and the first sensing type includes one or more of the following cases.

In the case where the Sensing Type field takes a first value, the first sensing type is the coordinated monostatic sensing.

In the case where the Sensing Type field takes a second value, the first sensing type is the coordinated bistatic sensing.

In the case where the Sensing Type field takes a third value, the first sensing type is the bistatic sensing.

In the case where the Sensing Type field takes a fourth value, the first sensing type is the multistatic sensing.

In the case where the Sensing Type field is a fifth value, the first sensing type is the monostatic sensing.

In some embodiments, the first value is set to be 0, the second value is set to be 1, the third value is set to be 2, the fourth value is set to be 3, and the fifth value is set to be 4. The corresponding relationship between the value of the Sensing Type field and the sensing type is illustrated in Table 1 hereinafter.

TABLE 1
Corresponding Relationship between Value
of Sensing Type Field and Sensing Type

| Value | Description |
|---|---|
| 0 | Coordinated monostatic sensing |
| 1 | Coordinated bistatic sensing |
| 2 | Bistatic sensing |
| 3 | Multistatic sensing |
| 4 | Monostatic sensing |
| 5-7 | Reserved |

The Sensing Type field being 0 indicates that the coordinated monostatic sensing is performed.

The Sensing Type field being 1 indicates that the coordinated bistatic sensing is performed.

The Sensing Type field being 2 indicates that the bistatic sensing is performed.

The Sensing Type field being 3 indicates that the multistatic sensing is performed.

The Sensing Type field being 4 indicates that the monostatic sensing is performed.

Values 5 to 7 of the Sensing Type field are reserved fields.

### 1.2.2 the First Sensing Type is Indicated Based on a DMG SBP Parameters Element Carried in an SBP Request Frame

The DMG SBP Parameters element indicates operation parameters relevant to the requested sensing by proxy process. The DMG SBP Parameters Control field defines the format of the DMG SBP Parameters element. Therefore, the Monomeric Sensing field can be added in the DMG SBP Parameters element for indicating monostatic sensing.

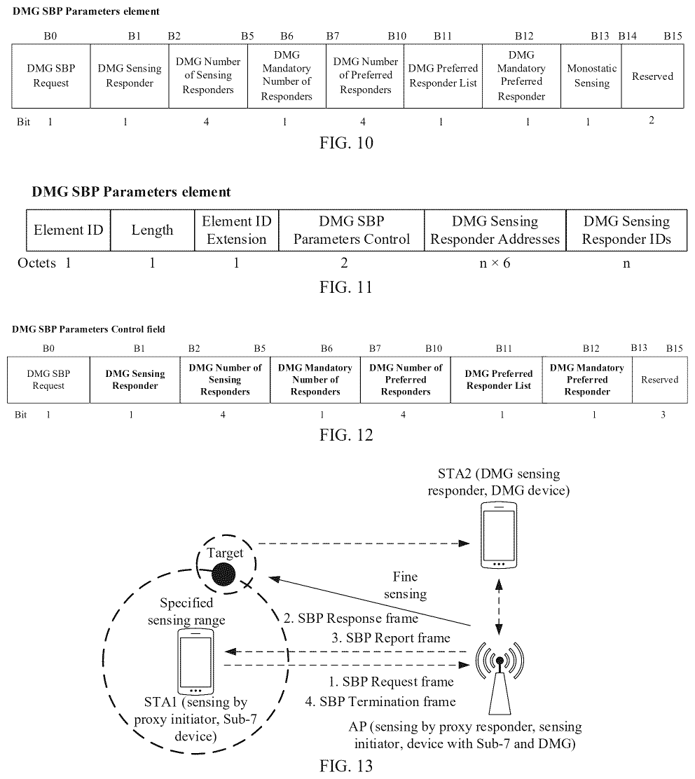

In some embodiments, the field structure of the DMG SBP Parameters element is illustrated in FIG. 10, and includes: a DMG SBP Request field, a DMG Sensing Responder field, a DMG Number of Sensing Responders field, a DMG Mandatory Number of Responders field, a DMG Number of Preferred Responders field, a DMG Preferred Responder List field, a DMG Mandatory Preferred Responder field, a Monostatic Sensing field, and a Reserved field which are sequentially arranged.

The DMG SBP Request field occupies bit position B0 and includes 1 bit in total, the DMG Sensing Responder field occupies bit position B1 and includes 1 bit in total, and the DMG Number of Sensing Responders field occupies bit positions B2-B5 and includes 4 bits in total. The DMG Mandatory Number of Responders field occupies bit position B6 and includes 1 bit in total, the DMG Number of Preferred Responders field occupies bit positions B7-B10 and includes 4 bits in total, the DMG Preferred Responder List field occupies bit position B11 and includes 1 bit in total, the DMG Mandatory Preferred Responder field occupies bit position B12 and includes 1 bit in total, the Monostatic Sensing field occupies bit position B13 and includes 1 bit in total, and the Reserved field occupies bit positions B14-B15 and includes 2 bits in total.

In some embodiments, the value of the DMG SBP Request field being a first value indicates that the DMG SBP Parameters element is transmitted by the SBP Request frame. The value of the Monostatic Sensing field being a second value indicates that the monostatic sensing type is requested by the sensing by proxy initiator. Meanwhile, the Sensing Type field in the Measurement Setup Control field in the DMG Sensing Measurement Setup element in the SBP Request frame is set as a reserved value or invalid value. The value of the Monostatic Sensing field being the first value indicates that the sensing type is indicated by the Sensing Type field.

In some embodiments, the value of the DMG SBP Request field being 1 indicates that the DMG SBP Parameters element is transmitted by the SBP Request frame. The value of the Monostatic Sensing field being 1 indicates that the monostatic sensing type is requested by the sensing by proxy initiator. Meanwhile, the Sensing Type field in the Measurement Setup Control field in the DMG Sensing Measurement Setup element in the SBP Request frame is set as a reserved value or invalid value. The value of the Monostatic Sensing field being 0 indicates that the sensing type is indicated by the Sensing Type field.

In some embodiments, the value of the DMG SBP Request field being the second value indicates that the DMG SBP Parameters element is transmitted by the SBP Response frame, and in this case, the Monostatic Sensing field is reserved.

In some embodiments, the value of the DMG SBP Request field being 0 indicates that the DMG SBP Parameters element is transmitted by the SBP Response frame, and in this case, the Monostatic Sensing field is reserved.

### 1.2.3 the First Sensing Type is Indicated Based on a Combination of a DMG SBP Parameters Element and a DMG Sensing Measurement Setup Element Carried in an SBP Request Frame

In some embodiments, in the case where the Sensing Type field in the Measurement Setup field in the DMG Sensing Measurement Setup element in the SBP Request frame (or SBP Response frame) takes a first value, the indicated sensing type is coordinated monostatic sensing. In this case, in the case where a value of at least one subfield in the DMG SBP Parameters element takes a predetermined value corresponding to the subfield, the first sensing type indicated by the SBP Request frame is indicated as a Monostatic Sensing type.

In some embodiments, the field structure of the DMG SBP Parameters element is illustrated in FIG. 11, and includes: an Element ID field, a Length field, an Element ID Extension field, a DMG SBP Parameters Control field, a DMG Sensing Responder Addresses field, and a DMG Sensing Responder IDs field which are sequentially arranged.

The Element ID field occupies 1 octet, the Length field occupies 1 octet, the Element ID Extension field occupies 1 octet, the DMG SBP Parameters Control field occupies 2 octets, the DMG Sensing Responder Addresses field occupies n*6 octets, and the DMG Sensing Responder IDs field occupies n octets.

In some embodiments, the field structure of the DMG SBP Parameters Control field is illustrated in FIG. 12, and includes: a DMG SBP Request field, a DMG Sensing Responder field, a DMG Number of Sensing Responders field, a DMG Mandatory Number of Responders field, a DMG Number of Preferred Responders field, a DMG Preferred Responder List field, a DMG Mandatory Preferred Responder field, and a Reserved field which are sequentially arranged.

The DMG SBP Request field occupies bit position B0 and includes 1 bit in total, the DMG Sensing Responder field occupies bit position B1 and includes 1 bit in total, and the DMG Number of Sensing Responders field occupies bit positions B2-B5 and includes 4 bits in total. The DMG Mandatory Number of Responders field occupies bit position B6 and includes 1 bit in total, the DMG Number of Preferred Responders field occupies bit positions B7-B10 and includes 4 bits in total, the DMG Preferred Responder List field occupies bit position B11 and includes 1 bit in total, the DMG Mandatory Preferred Responder field occupies bit position B12 and includes 1 bit in total, and the Reserved field occupies bit positions B13-B15 and includes 3 bits in total.

In some embodiments, the DMG SBP Request field being a first value indicates that the DMG SBP Parameters element is transmitted by the SBP Request frame. The DMG SBP Request field being a second value indicates that the DMG SBP Parameters element is transmitted by the SBP Response frame.

In some embodiments, the first value is set to be 1, and the second value is set to be 0.

In some embodiments, the value of the DMG Sensing Responder field should be set to be a first value, which indicates that the DMG sensing by proxy initiator does not request to participate in the DMG sensing process as a sensing responder. For example, the first value is set to be 0.

In some embodiments, the DMG Number of Sensing Responders field and the DMG Mandatory Number of Responders field are reserved.

In some embodiments, the value of the DMG Number of Preferred Responders subfield should be set to be a first value, which indicates that the DMG Sensing Responder Addresses field contains one DMG sensing responder with the known MAC address. For example, the first value is set to be 1.

In some embodiments, the value of the DMG Preferred Responder List field should be set to be a first value, which indicates that the DMG sensing by proxy initiator provides the DMG Sensing Responder Addresses field. For example, the first value is set to be 1.

In some embodiments, the value of the DMG Mandatory Preferred Responder field should be set to be a first value, which indicates that only the responder contained in the DMG Sensing Responder Addresses field can be selected as the sensing responder.

For example, the first value is set to be 1.

In some embodiments, the value of the DMG Sensing Responder Addresses field should be set to be the MAC address of the DMG SBP responder (AP), which indicates that only the DMG SBP responder can be selected as the DMG sensing responder, that is, the DMG SBP responder is both the DMG sensing initiator and the DMG sensing responder, and implicitly indicates that the sensing type is the monostatic sensing type.

In some embodiments, the DMG Sensing Responder IDs field should be set to be an Association Identifier (AID) of the DMG SBP responder.

1.3. Processes in which the Low-Frequency Band Device Requests to Perform Sensing Measurement of Monostatic Sensing of the High-Frequency Band

The first sensing type as monostatic sensing is taken as an example. Referring to FIGS. 8 and 9, the detailed processes in which the low-frequency band device requests to perform the sensing measurement of the monostatic sensing of the high-frequency band are as follows.

In process 0, the sensing by proxy initiator (STA1, the Sub-7 device) completes device discovery and interaction of various sensing capabilities by exchanging a plurality of management frames with the sensing by proxy responder (AP).

In some embodiments, the management frame includes at least one of a Beacon frame, a Probe Request frame, an Association Request frame, or a Reassociation Request frame. The management frame carries a DMG Sensing Beam Descriptor element for exposing a sensing transmitter beam and a sensing receiver beam which may be supported by the management frame.

In process 1, the sensing by proxy initiator (STA1, the Sub-7 device) initiates a DMG sensing by proxy process by transmitting an SBP Request frame to the sensing by proxy responder (AP).

In some embodiments, the SBP Request frame carries the DMG SBP Parameters element, and the DMG Sensing Measurement Setup element.

In some embodiments, taking as an example that the DMG Sensing Measurement Setup element in the SBP Request frame indicates the first sensing type, the Sensing Type field in the Measurement Setup Control field in the DMG Sensing Measurement Setup element is 4, that is, the monostatic sensing type.

In process 2, the sensing by proxy responder (AP) indicates acceptance of the sensing by proxy task by transmitting an SBP Response frame to the sensing by proxy initiator (STA1, the Sub-7 device).

In some embodiments, the SBP Response frame carries the DMG SBP Parameters element, and the DMG Sensing Measurement Setup element. The SBP Response frame further carries a DMG Sensing Image Range Axis LUT element, a DMG Sensing Image Doppler Axis LUT element, a Beam Descriptor field, and a DMG Measurement Setup ID field, which are used to assist the sensing by proxy initiator in parsing the DMG measurement report.

In process 3, the sensing by proxy responder (AP) completes the DMG sensing measurement process based on the setting in the SBP Request frame, and completes monostatic sensing by transmitting monostatic PPDUs.

In process 4, the sensing by proxy responder (AP) notifies the DMG sensing measurement result by transmitting an SBP Report frame to the sensing by proxy initiator (STA1, the Sub-7 device).

In some embodiments, the SBP Report frame carries the DMG Sensing Report Control element, and the DMG Sensing Report element.

In process 5, the sensing by proxy initiator (STA1, the Sub-7 device) indicates termination of the relevant DMG sensing by transmitting an SBP Termination frame to the sensing by proxy responder (AP).

In some embodiments, the SBP Termination frame carries the DMG Measurement Setup ID, and the DMG SBP Termination Control field.

### 2. A Low-Frequency Band Device Requests to Perform Sensing Measurement of a First Sensing Range of a High-Frequency Band.

2.1 A Process in which the Low-Frequency Band Device Requests to Perform Sensing Measurement of the First Sensing Range of the High-Frequency Band

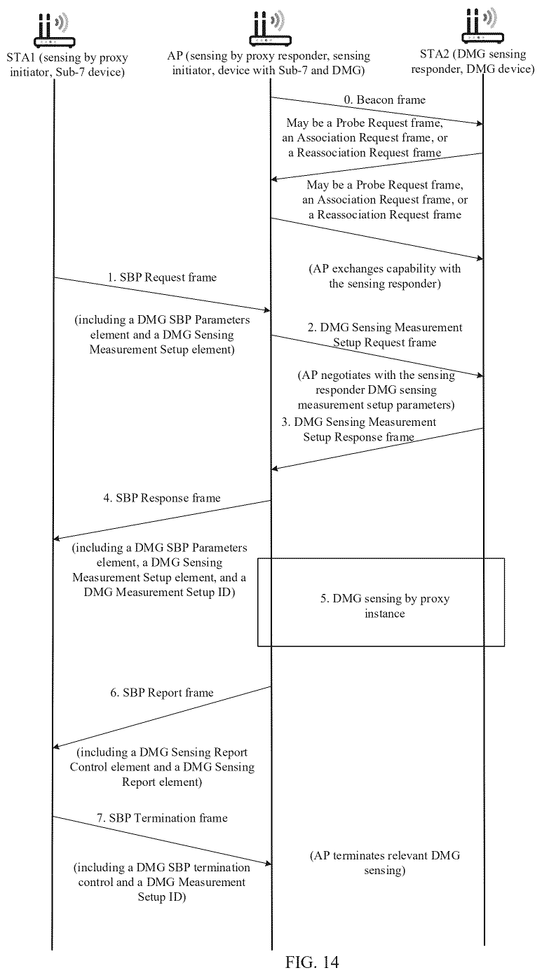

FIG. 13 is a diagram of a scenario in which a low-frequency band device requests to perform sensing measurement of a first sensing range of a high-frequency band according to some embodiments of the present disclosure. FIG. 14 is a flowchart in which a low-frequency band device requests to perform sensing measurement of a first sensing range of a high-frequency band according to some embodiments of the present disclosure.

FIGS. 13 and 14 relate to a sensing by proxy initiator (STA1, a Sub-7 device), a sensing by proxy responder (AP, a device with both DMG and Sub-7 sensing capabilities), a sensing initiator (AP), and a DMG sensing responder (STA2, a DMG device). The sensing by proxy responder is configured to respond to an SBP request of the sensing by proxy initiator, and meanwhile acts as the sensing initiator for initiating sensing.

Referring to FIGS. 13 and 14, the process in which the low-frequency band device requests to perform sensing measurement of the first sensing range of the high-frequency band is briefly described hereinafter.

In process 0, the sensing initiator broadcasts a Beacon frame, and the DMG sensing responder actively transmits a Probe Request frame, an Association Request frame, or a Reassociation Request frame to the sensing initiator and receives the Probe Request frame, the Association Request frame, or the Reassociation Request frame returned by the sensing initiator for exchanging sensing capability information of the sensing initiator and the DMG sensing responder.

In process 1, the sensing by proxy initiator (STA1, the Sub-7 device) initiates a DMG sensing by proxy process by transmitting an SBP Request frame to the sensing by proxy responder (AP).

In some embodiments, the SBP Request frame carries at least one of a DMG SBP Parameters element, or a DMG Sensing Measurement Setup element.

In process 2, the sensing by proxy responder (AP) negotiates with the sensing responder (STA2, the DMG device) operation parameters in the DMG sensing measurement process by transmitting a DMG Sensing Measurement Setup Request frame to the DMG sensing responder.

In process 3, the DMG sensing responder (STA2, the DMG device) indicates confirmation of establishing the DMG sensing measurement by transmitting a DMG Sensing Measurement Setup Response frame to the sensing by proxy responder (AP).

In process 4, the sensing by proxy responder (AP) indicates acceptance of the sensing by proxy task by transmitting an SBP Response frame to the sensing by proxy initiator (STA1, the Sub-7 device).

In some embodiments, the SBP Response frame carries at least one of the DMG SBP Parameters element, the DMG Sensing Measurement Setup element, or a DMG Measurement Setup ID.

In process 5, the sensing by proxy responder (AP) and the DMG sensing responder (STA2, the DMG device) complete the DMG sensing measurement process based on the setting in the SBP Request frame.

In process 6, the sensing by proxy responder (AP) notifies the DMG sensing measurement result by transmitting an SBP Report frame to the sensing by proxy initiator (STA1, the Sub-7 device).

In some embodiments, the SBP Report frame carries at least one of a DMG Sensing Report Control element, or a DMG Sensing Report element.

In process 7, the sensing by proxy initiator (STA1, the Sub-7 device) indicates termination of the relevant DMG sensing by transmitting an SBP Termination frame to the sensing by proxy responder (AP).

In some embodiments, the SBP Termination frame carries at least one of a DMG Measurement Setup ID, or a DMG SBP Termination Control field.

### 2.2 Frame Format of the Low-Frequency Band Device

### 2.2.1 the First Sensing Range is Indicated Based on a DMG SBP Parameters Element Carried in an SBP Request Frame

In some embodiments, the first sensing range is indicated by the DMG SBP Parameters element carried in the SBP Request frame. The field structure of the DMG SBP Parameters element is illustrated in FIG. 15, and includes: an Element ID field, a Length field, an Element ID Extension field, a DMG SBP Parameters Control field, a DMG Sensing Responder Addresses field, a DMG Sensing Responder IDs field, a Target Orientation field, an LCI field, and a Peer Orientation field which are sequentially arranged.

The Element ID field occupies 1 octet, the Length field occupies 1 octet, the Element ID Extension field occupies 1 octet, the DMG SBP Parameters Control field occupies 2 octets, the DMG Sensing Responder Addresses field occupies n*6 octets, the DMG Sensing Responder IDs field occupies n octets, the Target Orientation field occupies 5 octets, the LCI field occupies 1 octet, and the Peer Orientation field occupies 2 octets.

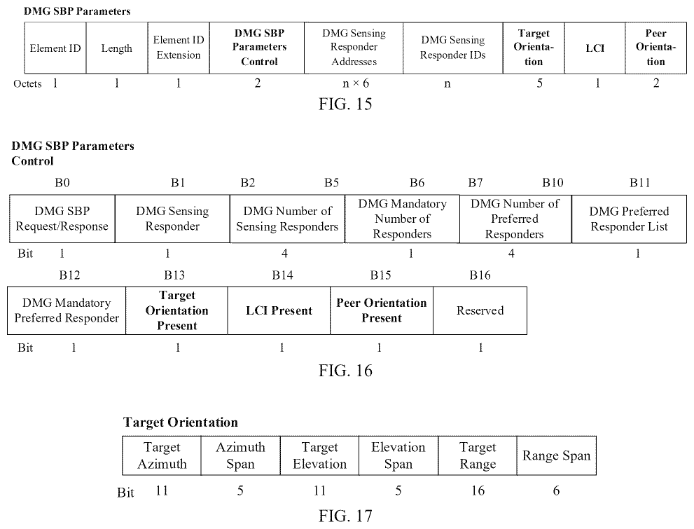

In some embodiments, the field structure of the DMG SBP Parameters Control field is illustrated in FIG. 16, and includes: a DMG SBP Request/Response field, a DMG Sensing Responder field, a DMG Number of Sensing Responders field, a DMG Mandatory Number of Responders field, a DMG Number of Preferred Responders field, a DMG Preferred Responder List field, a DMG Mandatory Preferred Responder field, a Target Orientation Present field, an LCI Present field, a Peer Orientation Present field, and a Reserved field which are sequentially arranged.

The DMG SBP Request/Response field occupies bit position B0 and includes 1 bit in total, the DMG Sensing Responder field occupies bit position B1 and includes 1 bit in total, and the DMG Number of Sensing Responders field occupies bit positions B2-B5 and includes 4 bits in total. The DMG Mandatory Number of Responders field occupies bit position B6 and includes 1 bit in total, the DMG Number of Preferred Responders field occupies bit positions B7-B10 and includes 4 bits in total, the DMG Preferred Responder List field occupies bit position B11 and includes 1 bit in total, the DMG Mandatory Preferred Responder field occupies bit position B12 and includes 1 bit in total, the Target Orientation Present field occupies bit position B13 and includes 1 bit in total, the LCI Present field occupies bit position B14 and includes 1 bit in total, the Peer Orientation Present field occupies bit position B15 and includes 1 bit in total, and the Reserved field occupies bit position B16 and includes 1 bit in total.

In some embodiments, whether the Target Orientation field is present is indicated by a value of the Target Orientation Present field. The Target Orientation Present field being a first value indicates that the DMG SBP Parameters element contains the Target Orientation field. The Target Orientation Present field being a second value indicates that the DMG SBP Parameters element does not contain the Target Orientation field. For example, the first value is set to be 1, and the second value is set to be 0.

In some embodiments, whether the LCI field is present is indicated by the LCI Present field. In the case where the LCI Present field takes a first value, the DMG SBP Parameters element contains LCI. In the case where the LCI Present field takes a second value, the DMG SBP Parameters element does not contain LCI. For example, the first value is set to be 1, and the second value is set to be 0.

In some embodiments, whether the Peer Orientation field is present is indicated by the Peer Orientation Present field. The Peer Orientation Present field being a first value indicates that the DMG SBP Parameters element contains the Peer Orientation field. The Peer Orientation Present field being a second value indicates that the DMG SBP Parameters element does not contain the Peer Orientation field. For example, the first value is set to be 1, and the second value is set to be 0.

In some embodiments, the Target Orientation field contains the specific location where the sensing by proxy initiator wants to make fine measurement, i.e., the azimuth, elevation, and range at which the target is located.

In some embodiments, the field structure of the Target Orientation field is illustrated in FIG. 17, and includes: a Target Azimuth subfield, an Azimuth Span subfield, a Target Elevation subfield, an Elevation Span subfield, a Target Range subfield, and a Range Span subfield which are sequentially arranged.

The Target Azimuth subfield occupies 11 bits, the Azimuth Span subfield occupies 5 bits, the Target Elevation subfield occupies 11 bits, the Elevation Span subfield occupies 5 bits, the Target Range subfield occupies 16 bits, and the Range Span subfield occupies 6 bits.

In some embodiments, the Target Azimuth subfield indicates an azimuth of the target relative to the sensing by proxy initiator, with a unit of (360/2048)°.

In some embodiments, the Azimuth Span subfield indicates a span size of the azimuth, which is calculated according to the following formula:

Azimuth Span=min(max(round(3·log 2(u·2048/360)),0),31)

wherein u is the azimuth extension, with a unit of (360/2048)°.

In some embodiments, the Target Elevation subfield indicates an elevation of the target relative to the sensing by proxy initiator, with a unit of (360/2048)°.

In some embodiments, the Elevation Span subfield indicates a span size of the elevation, which is calculated according to the following formula:

$$Elevation Span = min ( max ( round ( 3 \cdot log 2 ( u \cdot 2048 / 360 ) ) , 0 ) , 31 )$$

wherein u is the elevation extension, with a unit of (360/2048) °.

In some embodiments, the Target Range subfield indicates a range of the target relative to the sensing by proxy initiator, with a unit of millimeter.

In some embodiments, the Range Span subfield indicates a span size of the range, which is calculated according to the following formula:

$$Range Span = mi n ( round ( 4 \cdot log 2 ( u ) ) , 63 )$$

wherein u is the range extension, with a unit of millimeter.

In some embodiments, the LCI field carries the location information of the sensing by proxy initiator.

In some embodiments, the Peer Orientation field contains the azimuth, elevation, and range of the sensing by proxy responder that are measured by the sensing by proxy initiator.

In some embodiments, the Azimuth subfield indicates an azimuth direction of the sensing by proxy responder that is measured by the sensing by proxy initiator, with a unit of (360/4096)°, taking a value of 0 to 4095.

In some embodiments, the Elevation subfield indicates an elevation direction of the sensing by proxy responder that is measured by the sensing by proxy initiator, with a unit of (180/4096)°, taking a value of −2048 to 2047.

In some embodiments, the Rang subfield indicates a range of the sensing by proxy responder that is measured by the sensing by proxy initiator, with a unit of millimeter.

2.3. Processes in which the Low-Frequency Band Device Requests to Perform Sensing Measurement of the First Sensing Range of the High-Frequency Band

Referring to FIGS. 13 and 14, the detailed processes in which the low-frequency band device requests to perform sensing measurement of the first sensing range of the high-frequency band are as follows.

In process 0, the sensing initiator broadcasts the Beacon frame, and the DMG sensing responder actively transmits the Probe Request frame, the Association Request frame, or the Reassociation request frame to the sensing initiator and receives the Probe Request frame, the Association Request frame, or the Reassociation Request frame returned by the sensing initiator for exchanging sensing capability information of the sensing initiator and the DMG sensing responder.

In process 1, the sensing by proxy initiator (STA1, the Sub-7 device) initiates the DMG sensing by proxy process by transmitting the SBP Request frame to the sensing by proxy responder (AP).

In some embodiments, the SBP Request frame carries the DMG SBP Parameters element, and the DMG Sensing Measurement Setup element.

In some embodiments, the Sensing Type field in the Measurement Setup Control field in the DMG Sensing Measurement Setup element is 2, namely, the bistatic sensing type is taken as an example. Taking an example that the SBP Request frame includes the DMG SBP Parameters element in FIG. 16, the LCI Present field, the Target Orientation Present field, and the Peer Orientation Present field are set to be the first value, that is, the DMG SBP Parameters element carries the location information of the sensing by proxy initiator, and the measured direction and range where the sensing by proxy responder and the target are located.

In process 2, the sensing by proxy responder (AP) negotiates with the DMG sensing responder (STA2, the DMG device) the operation parameters in the DMG sensing measurement process by transmitting the DMG Sensing Measurement Setup Request frame to the DMG sensing responder.

In process 3, the DMG sensing responder (STA2, the DMG device) indicates confirmation of establishing the DMG sensing measurement by transmitting a DMG Sensing Measurement Setup Response frame to the sensing by proxy responder (AP).

In process 4, the sensing by proxy responder (AP) indicates acceptance of the sensing by proxy task by transmitting the SBP Response frame to the sensing by proxy initiator (STA1, the Sub-7 device).

In some embodiments, the SBP Response frame carries the DMG SBP Parameters element, the DMG Sensing Measurement Setup element, and the DMG Measurement Setup ID field. The SBP Response frame further carries the DMG Sensing Image Range Axis LUT element, the DMG

Sensing Image Doppler Axis LUT element, the Beam Descriptor field, and the DMG Measurement Setup ID field, which are used to assist the sensing by proxy initiator in parsing the DMG measurement report.

In process 5, the sensing by proxy responder (AP) and the DMG sensing responder (STA2, the DMG device) complete the DMG sensing measurement process based on the setting in the SBP Request frame.

In process 6, the sensing by proxy responder (AP) notifies a DMG sensing measurement result by transmitting the SBP Report frame to the sensing by proxy initiator (STA1, the Sub-7 device).

In some embodiments, the SBP Report frame carries the DMG Sensing Report Control element, and the DMG Sensing Report element.

In process 7, the sensing by proxy initiator (STA1, the Sub-7 device) indicates termination of the related DMG sensing by transmitting the SBP Termination frame to the sensing by proxy responder (AP).

In some embodiments, the SBP Termination frame carries at least one of the DMG Measurement Setup ID, or a DMG SBP Termination Control field.

### 2.4 Example of Calculation of the First Sensing Range

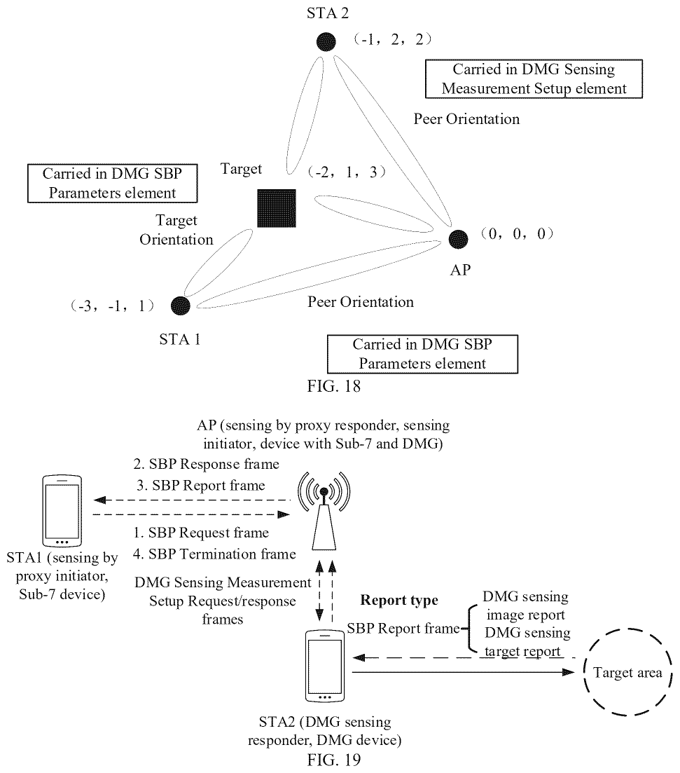

FIG. 18 is a schematic diagram of a scenario in which a first sensing range is calculated according to some embodiments of the present disclosure. FIG. 18 relates to a sensing by proxy initiator (STA1, a Sub-7 device), a sensing by proxy responder (AP, a device with both DMG and Sub-7 sensing capabilities), and a DMG sensing responder (STA2, a DMG device). The calculation process is as follows:

Unknown parameters: xyz coordinates of the target.

Known parameters:

The xyz coordinates of AP are (0, 0, 0), the xyz coordinates of STA1 are (−3, −1, 1), and the xyz coordinates of STA2 are (−1, 2, 2).

Target orientation:

Azimuth φ₁=1.107148717794090; Elevation θ₁=0.729727656226966; Range d₁=3.

Peer orientation between STA1 and AP:

Azimuth φ₂=0.321750554396642: Elevation θ₂=−0.306277369169669; Range d₂=3.316624790355400.

Peer orientation between AP and STA2:

Azimuth φ₃=2.034443935795703; elevation θ₃=0.729727656226966; range d₃=3.

According to the geometric relationship, the vector between the target and AP may be calculated as follows:

v₁=d₁(cos φ₁ cos θ₁, sin θ₁, cos θ₁, sin θ₁)−d₂(cos φ₂ cos θ₂, sin φ₂ cos θ₂, sin θ₂)=(−2,1,3)

The vector between the target and STA2 is:

$${v}_{2} = {v}_{1} - {d}_{3} ( cos {φ}_{3} cos {θ}_{3} , sin {φ}_{3} cos {θ}_{3} , sin {θ}_{3} ) = ( - 1 , - 1 , 1 )$$

It can be seen that the target has an azimuth of 2.677945044588987 and an elevation of 0.930274014115472 with regard to AP, and the target has an azimuth of −2.356194490192345 and an elevation of 0.615479708670387 with regard to STA2.

### 3. A Low-Frequency Band Device Requests to Perform Sensing Measurement of a High-Frequency Band and Parses a Sensing Report.

3.1 A Process in which the Low-Frequency Band Device Requests to Perform Sensing Measurement of the High-Frequency Band and Parses the Sensing Report

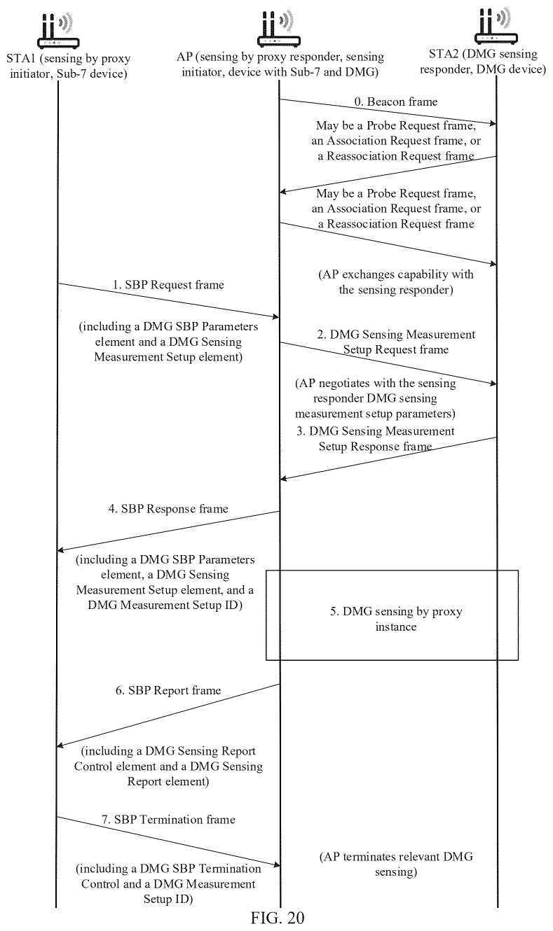

FIG. 19 is a diagram of a scenario in which a low-frequency band device requests to perform sensing measurement of a high-frequency band and parses a sensing report according to some embodiments of the present disclosure. FIG. 20 is a flowchart in which a low-frequency band device requests to perform sensing measurement of a high-frequency band and parses a sensing report according to some embodiments of the present disclosure.

FIGS. 19 and 20 relate to a sensing by proxy initiator (STA1, a Sub-7 device), a sensing by proxy responder (AP, a device with both DMG and Sub-7 sensing capabilities), a sensing initiator (AP), and a DMG sensing responder (STA2, a DMG device). The sensing by proxy responder is used to respond to an SBP request of the sensing by proxy initiator, and meanwhile acts as the sensing initiator for initiating sensing.

Referring to FIGS. 19 and 20, the process in which the low-frequency band device requests to perform sensing measurement of the high-frequency band and parses the sensing report is briefly described hereinafter.

In process 0, the sensing initiator broadcasts the Beacon frame, and the DMG sensing responder actively transmits the Probe Request frame, the Association Request frame, or the Reassociation Request frame to the sensing initiator and receives the Probe Request frame, the Association Request frame, or the Reassociation Request frame returned by the sensing initiator for exchanging sensing capability information of the sensing initiator and the DMG sensing responder.

In process 1, the sensing by proxy initiator (STA1, the Sub-7 device) initiates the DMG sensing by proxy process by transmitting the SBP Request frame to the sensing by proxy responder (AP).

In some embodiments, the SBP Request frame carries at least one of a DMG SBP Parameters element, or a DMG Sensing Measurement Setup element.

In process 2, the sensing by proxy responder (AP) negotiates with the DMG sensing responder (STA2, the DMG device) the operation parameters in the DMG sensing measurement process by transmitting the DMG Sensing Measurement Setup Request frame to the DMG sensing responder.

In process 3, the DMG sensing responder (STA2, the DMG device) indicates confirmation of establishing the DMG sensing measurement by transmitting a DMG Sensing Measurement Setup Response frame to the sensing by proxy responder (AP).

In process 4, the sensing by proxy responder (AP) indicates acceptance of the sensing by proxy task by transmitting the SBP Response frame to the sensing by proxy initiator (STA1, the Sub-7 device).

In some embodiments, the SBP Response frame carries at least one of the DMG SBP Parameters element, the DMG Sensing Measurement Setup element, or a DMG Measurement Setup ID.

In process 5, the sensing by proxy responder (AP) and the DMG sensing responder (STA2, the DMG device) complete the DMG sensing measurement process based on the setting in the SBP Request frame.

In process 6, the sensing by proxy responder (AP) notifies a DMG sensing measurement result by transmitting the SBP Report frame to the sensing by proxy initiator (STA1, the Sub-7 device).

In some embodiments, the SBP Report frame carries at least one of a DMG Sensing Report Control element, or a DMG Sensing Report element.

In process 7, the sensing by proxy initiator (STA1, the Sub-7 device) indicates termination of the related DMG sensing by transmitting the SBP Termination frame to the sensing by proxy responder (AP).

In some embodiments, the SBP Termination frame carries at least one of the DMG Measurement Setup ID, or a DMG SBP Termination Control field.

### 3.2 Frame Format of the Low-Frequency Band Device

### 3.2.1 SBP Response Frame

In some embodiments, the SBP Response frame carries information for assisting in parsing the sensing report.

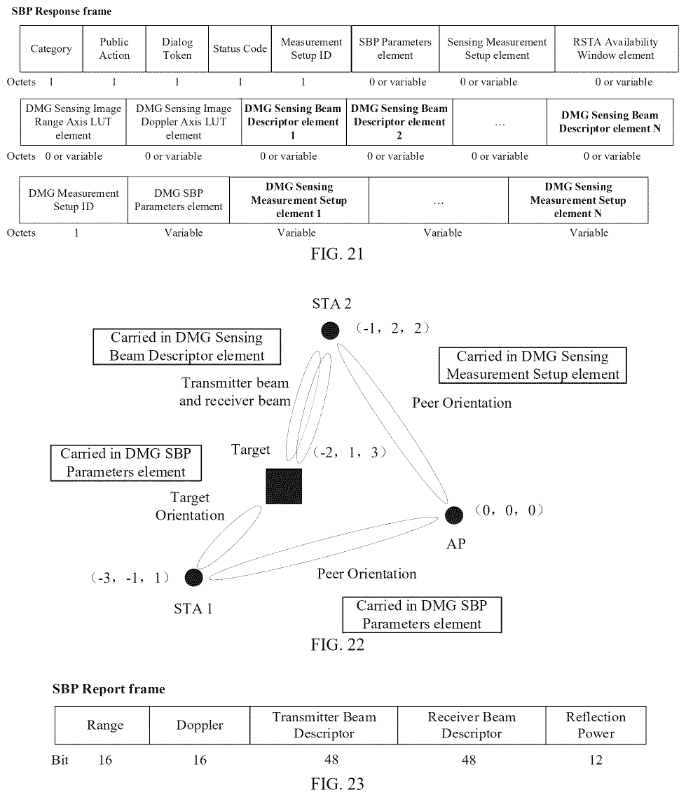

In some embodiments, the frame structure of the SBP Response frame is illustrated in FIG. 21, and includes: a Category field, a Public Action field, a Dialog Token field, a Status Code field, a Measurement Setup ID field, an SBP Parameters element, a Sensing Measurement Parameters element, an RSTA Availability Window element, a DMG Sensing Image Range Axis LUT element, a DMG Sensing Image Doppler Axis LUT element, a DMG Sensing Beam Descriptor element 1, a DMG Sensing Beam Descriptor element 2 to a DMG Sensing Beam Descriptor element N, a DMG Measurement Setup ID field, a DMG SBP Parameters element, and a DMG Sensing Measurement Setup element 1 to a DMG Sensing Measurement Setup element N.

The Category field occupies 1 octet, the Public Action field occupies 1 octet, the Dialog Token field occupies 1 octet, the Status Code field occupies 1 octet, the Measurement Setup ID field occupies 1 octet, the SBP Parameters element occupies 0 octet or has a variable number of octets, the Sensing Measurement Parameters element occupies 0 octet or has a variable number of octets, the RSTA Availability Window element occupies 0 octet or has a variable number of octets, the DMG Sensing Image Range Axis LUT element occupies 0 octet or has a variable number of octets, the DMG Sensing Image Doppler Axis LUT element occupies 0 octet or has a variable number of octets, the DMG Sensing Beam Descriptor element 1 occupies 0 octet or has a variable number of octets, the DMG Sensing Beam Descriptor element 2 occupies 0 octet or has a variable number of octets, . . . , the DMG Sensing Beam Descriptor element N occupies 0 octet or has a variable number of octets, the DMG Measurement Setup ID field occupies 1 octet, the DMG SBP Parameters element occupies a variable number of octets, the DMG Sensing Measurement Setup element 1 occupies a variable number of octet, . . . , and the DMG Sensing Measurement Setup element N occupies a variable number of octets.

In some embodiments, the DMG Sensing Beam Descriptor element contains information of beams of each sensing by proxy responder. The number N indicates the number of sensing by proxy responders actually participating in the DMG sensing by proxy process, and the number N is set as a value of a DMG Number of Sensing Responders field in the DMG SBP Parameters Control field in the DMG SBP parameters element. The beam information included in the DMG Sensing Beam Descriptor element may be used as a descriptor of a transmitter beam, or a descriptor of a receiver beam.

In some embodiments, the DMG Sensing Measurement Setup element indicates relevant parameters of the DMG Sensing Measurement Setup. The number N indicates the number of sensing by proxy responders actually participating in the DMG sensing by proxy process, and the number N is set as a value of a DMG Number of Sensing Responders field in the DMG SBP Parameters Control field in the DMG SBP Parameters element in the SBP Response frame.

In some embodiments, the order of the DMG Sensing Beam Descriptor element and the DMG Sensing Measurement Setup element should be the same as the order in an AID/USID list of DMG sensing responders participating in the DMG sensing by proxy process that is defined by the DMG Sensing Responder IDs field in the DMG SBP Parameters element. In this case, the DMG Sensing Responder IDs field is present, that is, a DMG Preferred Responder List subfield is set to be a first value. For example, the first value is set to be 1.

3.3. Processes in which the Low-Frequency Band Device Requests to Perform Sensing Measurement of the High-Frequency Band and Parses the Sensing Report

Referring to FIGS. 19 and 20, the detailed processes in which the low-frequency band device requests to perform sensing measurement of the high-frequency band and parses the sensing report are as follows.

In process 0, the sensing initiator broadcasts the Beacon frame, and the DMG sensing responder actively transmits the Probe Request frame, the Association Request frame, or the Reassociation Request frame to the sensing initiator and receives the Probe Request frame, the Association Request frame, or the Reassociation Request frame returned by the sensing initiator for exchanging sensing capability information of the sensing initiator and the DMG sensing responder.

In some embodiments, at least one of the Beacon frame, the Probe Request frame, the Association Request frame, or the Reassociation Request frame carries the DMG Sensing Beam Descriptor element for exposing a sensing transmitter beam and a sensing receiver beam which is supported.

In process 1, the sensing by proxy initiator (STA1, the Sub-7 device) initiates the DMG sensing by proxy process by transmitting the SBP Request frame to the sensing by proxy responder (AP).

In some embodiments, the SBP Request frame carries the DMG SBP Parameters element, and the DMG Sensing Measurement Setup element.

In some embodiments, a value of the Sensing Type field in the Measurement Setup Control field in the DMG Sensing Measurement Setup element is 0, which indicates that the sensing type is a coordinated monostatic sensing type.

In process 2, the sensing by proxy responder (AP) negotiates with the DMG sensing responder (STA2, the DMG device) the operation parameters in the DMG sensing measurement process by transmitting the DMG Sensing Measurement Setup Request frame to the DMG sensing responder.

In process 3, the DMG sensing responder (STA2, the DMG device) indicates confirmation of establishing the DMG sensing measurement by transmitting the DMG Sensing Measurement Setup Response frame to the sensing by proxy responder (AP).

In process 4, the sensing by proxy responder (AP) indicates acceptance of the sensing by proxy task by transmitting the SBP Response frame to the sensing by proxy initiator (STA1, the Sub-7 device).

In some embodiments, taking an SBP Response frame in FIG. 21 as an example, the SBP Response frame carries the DMG SBP Parameters element, the DMG Sensing Measurement Setup element, and the DMG Measurement Setup ID field. The SBP Response frame further carries the DMG Sensing Image Range Axis LUT element, the DMG Sensing Image Doppler Axis LUT element, the Beam Descriptor field, and the DMG Measurement Setup ID field, which are used to assist the sensing by proxy initiator in parsing the DMG measurement report.

In process 5, the sensing by proxy responder (AP) and the DMG sensing responder (STA2, the DMG device) complete the DMG sensing measurement process based on the setting in the SBP Request frame.

In process 6, the sensing by proxy responder (AP) notifies a DMG sensing measurement result by transmitting the SBP Report frame to the sensing by proxy initiator (STA1, the Sub-7 device).

In some embodiments, the SBP Report frame carries the DMG Sensing Report Control element, and the DMG Sensing Report element.

In process 7, the sensing by proxy initiator (STA1, the Sub-7 device) indicates termination of the related DMG sensing by transmitting the SBP Termination frame to the sensing by proxy responder (AP).

In some embodiments, the SBP Termination frame carries the DMG Measurement Setup ID, and the DMG SBP Termination Control field.

3.4 Example of a Scenario in which the Low-Frequency Band Device Parses the Sensing Report of the High-Frequency Band

FIG. 22 is a diagram of a scenario in which a low-frequency band device parses a sensing report of a high-frequency band according to some embodiments of the present disclosure. FIG. 22 relates to a sensing by proxy initiator (STA1, a Sub-7 device), a sensing by proxy responder (AP, a device with both DMG and Sub-7 sensing capabilities), and a DMG sensing responder (STA2, a DMG device).

The parameters are set as follows.

A DMG Sensing Report Type field in the DMG Sensing Report element is set to be 0, and a Range Axis Present field, a Doppler Axis Present field, a Receiver Beam Index Present field, and a Transmitter Beam Index Present field in an Axis Present field in the DMG Sensing Image Report Data element are set to be 1.

Taking the SBP Request frame in FIGS. 15 to 16 as an example, the LCI Present field and the Peer Orientation Present field in the DMG SBP Parameters Control field in the DMG SBP Parameters element are set to be 1, and the DMG SBP Parameters element carries the location information of STA1, and the measured direction and range where AP and the target are located. The LCI Present field and the Peer Orientation Present field in the Sensing Measurement Setup Control field in the DMG Sensing Measurement Setup element are set to be 1, and the DMG Sensing Measurement Setup element carries the location information of the device and the measured peer orientation.

In the case where the low-frequency band device receives the SBP Report frame of the high-frequency band device, a lists of transmitter beams or receiver beams (TX/RX Beam List) in the DMG Sensing Beam Descriptor element and the DMG Sensing Measurement Setup element of a sensing transmitter and a sensing receiver is found over the AID/UID carried in the SBP

Report frame, so as to acquire the azimuth q and elevation θ corresponding to a Transmitter Beam Index and a Receiver Beam Index in the sensing report. Then, the doppler value y and the range value d corresponding to a Doppler Axis and a Range Axis in the sensing report are acquired using the DMG Sensing Image Range Axis LUT element and the DMG Sensing Image Doppler Axis LUT element in the SBP Response frame.

Based on this, unknown parameters and known parameters in FIG. 22 may be expressed as follows.

Unknown parameters: xyz coordinates of the target

Known parameters:

The xyz coordinates of AP are (0, 0, 0), the xyz coordinates of STA1 are (−3, −1, 1), and the xyz coordinates of STA2 are (−1, 2, 2).

Angle and range of the target that is measured by STA2: azimuth φ₁=−2.356194490192345 elevation θ₁=0.615479708670387, and range d₁=1.732050807568877.

Peer direction between STA1 and AP: azimuth φ₂=0.321750554396642, elevation θ₂=−0.306277369169669, and range d₂=3.316624790355400.

Peer direction between AP and STA2: azimuth φ₃=2.034443935795703, elevation, θ₃=0.729727656226966, and range d₃=3.

According to the geometric relationship, the vector between the target and STA1 may be calculated as follows:

$$v = {d}_{1} ( cos {φ}_{1} cos {θ}_{1} , sin {φ}_{1} cos {θ}_{1} , sin {θ}_{1} ) + {d}_{2} ( cos {φ}_{2} c o s {θ}_{2} , sin {φ}_{2} cos {θ}_{2} , sin {θ}_{2} ) + {d}_{3} ( cos {φ}_{3} cos {θ}_{3} , sin {φ}_{3} cos {θ}_{3} , sin {θ}_{3} ) = ( 1 , 2 , 2 )$$

It can be seen that the azimuth and elevation of the target with respect to STA1 are 1.107148717794090 and 0.729727656226966, and the range is 3.

### 3.5 Optional Design of a Frame Format of the Low-Frequency Band Device

### 3.5.1 SBP Report Frame

In some other embodiments, for a scenario in which the low-frequency band device parses the sensing report of the high-frequency band, the DMG Sensing Measurement Setup element and the DMG Sensing Beam Descriptor element in the SBP Response frame in 3.2.1 are added in the SBP Report frame, so as to replace or supplement the SBP Response frame in 3.2.1.

In some other embodiments, the high-frequency band device directly transmits Range, Doppler, a beam receiving direction, and a beam transmitting direction in reflection subelements in the DMG Sensing Image Report Data element in the DMG Sensing Report element in the SBP Report frame, so as to replace the Range Axis, the Doppler Axis, the Receiver Beam Index, and the Transmitter Beam Index in the SBP Response frame.

In some embodiments, the frame structure of the SBP Report frame is illustrated in FIG. 23, and includes: a Range subfield, a Doppler subfield, a Transmitter Beam Descriptor subfield, a Receiver Beam Descriptor subfield, and a Reflection Power subfield which are sequentially arranged.

The Range subfield occupies 16 bits, the Doppler subfield occupies 16 bits, the Transmitter Beam Descriptor subfield occupies 48 bits, the Receiver Beam Descriptor subfield occupies 48 bits, and the Reflection Power subfield occupies 12 bits.

In some embodiments, the Range subfield indicates a range, with a unit of millimeter. The Doppler subfield indicates Doppler, with a unit of millimeter/second. The Transmitter Beam Descriptor subfield indicates information of transmitter beams used. The Receiver Beam Descriptor subfield indicates information of receiver beams used. The Reflection Power subfield indicates the reflected received power, with a unit of dBm. In this case, the DMG Sensing Beam Descriptor element, the DMG Sensing Image Range Axis LUT element, and the DMG Sensing Image Doppler Axis LUT element in the SBP Response frame may be omitted.

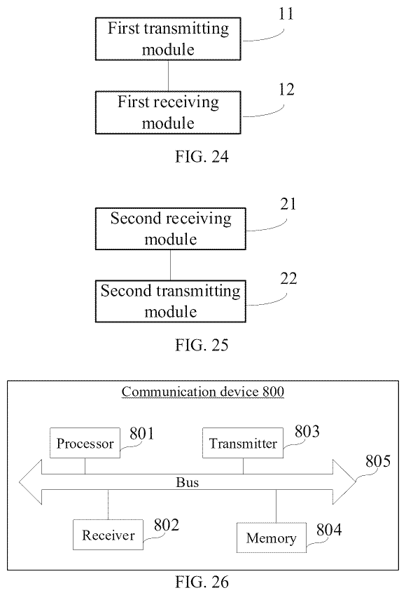

FIG. 24 is a structural block diagram of an apparatus for sensing by proxy according to some embodiments of the present disclosure. The apparatus includes: a first transmitting module 11 and a first receiving module 12.

The first transmitting module 11 is configured to transmit an SBP Request frame to a sensing by proxy responder, wherein the SBP Request frame is used to request the sensing by proxy responder to perform sensing measurement of a second frequency band in a proxy mode, and indicate at least one of a first sensing type or a first sensing range to the sensing by proxy responder.

The first receiving module 12 is configured to receive an SBP Response frame from the sensing by proxy responder.

The sensing by proxy responder is a device that supports both the first frequency band and the second frequency band.

The apparatus for sensing by proxy illustrated in FIG. 24 is applicable to the sensing by proxy initiator supporting the first frequency band.

In some embodiments, the SBP Request frame carries first information, wherein the first information indicates the first sensing type.

The first sensing type is one of a plurality of sensing types, wherein the plurality of sensing types include monostatic sensing.

In some embodiments, the first information includes at least one of: a Sensing Type field; a Monostatic Sensing field; or at least one subfield of an SBP Parameters element.

In some embodiments, the first information includes the Sensing Type field, and different values of the Sensing Type field correspond to different sensing types.

For example, a corresponding relationship between the value of the Sensing Type field and the sensing type includes one or more of the following cases. In some embodiments, in the case where the Sensing Type field takes a first value, the first sensing type is coordinated monostatic sensing. In the case where the Sensing Type field takes a second value, the first sensing type is coordinated bistatic sensing. In the case where the Sensing Type field takes a third value, the first sensing type is bistatic sensing. In the case where the Sensing Type field takes a fourth value, the first sensing type is multistatic sensing. In the case where the Sensing Type field takes a fifth value, the first sensing type is monostatic sensing.

In some embodiments, the first information includes the Monostatic Sensing field. In the case where the Monostatic Sensing field takes the first value, the first sensing type is not the monostatic sensing. In the case where the Monostatic Sensing field takes the second value, the first sensing type is the monostatic sensing.

In some embodiments, the first information further includes the Sensing Type field. In the case that the Monostatic Sensing field takes the first value, the first sensing type is a sensing type indicated by the value of the Sensing Type field.

In some embodiments, the first information includes the Sensing Type field and the at least one subfield of the SBP Parameters element. In the case where the Sensing Type field takes the first value and the at least one subfield of the SBP Parameters element takes a predetermined value corresponding to the subfield, the first sensing type is the monostatic sensing. In the case where the Sensing Type field takes the first value and the at least one subfield of the SBP Parameters element does not take the predetermined value corresponding to the subfield, the first sensing type is coordinated monostatic sensing. In the case where the Sensing Type field takes the second value, the first sensing type is coordinated bistatic sensing. In the case where the Sensing Type field takes the third value, the first sensing type is bistatic sensing. In the case where the Sensing Type field takes the fourth value, the first sensing type is multistatic sensing.

In some embodiments, the Sensing Type field is carried in a Sensing Measurement Setup element corresponding to the second frequency band; and the Sensing Measurement Setup element indicates operation parameters of the sensing measurement process. The monostatic Sensing Type field is carried in an SBP Parameters element corresponding to the second frequency band; and the SBP Parameters element indicates the operation parameters of the sensing measurement process. The at least one subfield of the SBP Parameters element is carried in the SBP Parameters element corresponding to the second frequency band.

In some embodiments, the Sensing Type field is carried in a Sensing Measurement Setup Control field in the Sensing Measurement Setup element corresponding to the second frequency band. The monostatic Sensing Type field is carried in an SBP Parameters Control field in the SBP Parameters element corresponding to the second frequency band. The at least one subfield of the SBP Parameters element is carried in the SBP Parameters Control field in the SBP Parameters element corresponding to the second frequency band.

In some embodiments, the SBP Request frame carries second information, wherein the second information indicates the first sensing range.

In some embodiments, the second information includes at least one of: a Target Orientation field, indicating location information of a target relative to the sensing by proxy initiator; an LCI field, indicating location information of the sensing by proxy initiator; or a Peer Orientation field, indicating location information of the sensing by proxy responder that is measured by the sensing by proxy initiator.

In some embodiments, the second information further includes at least one of the following additional fields: a Target Orientation Present field, indicating whether the Target Orientation field is present; an LCI Present field, indicating whether the LCI field is present; or a Peer Orientation Present field, indicating whether the Peer Orientation field is present.

In some embodiments, in the case where the Target Orientation Present field takes a first value, the Target Orientation field is not present. In the case where the Target Orientation Present field takes a second value, the Target Orientation field is present. In the case where the LCI Present field takes the first value, the LCI field is not present. In the case where the LCI Present field takes the second value, the LCI field is present. In the case where the Peer Orientation Present field takes the first value, the Peer Orientation field is not present. In the case where the Peer Orientation Present field takes the second value, the Peer Orientation field is present.

In some embodiments, the Target Orientation field includes at least one of: a Target Azimuth subfield, indicating an azimuth of the target relative to the sensing by proxy initiator; an Azimuth Span subfield, indicating a span size of the azimuth; a Target Elevation subfield, indicating an elevation of the target relative to the sensing by proxy initiator; an Elevation Span subfield, indicating a span size of the elevation; a Target Range subfield, indicating a range of the target relative to the sensing by proxy initiator; or a Range Span subfield, indicating a span size of the range.

In some embodiments, the Peer Orientation field includes at least one of: an Azimuth subfield, indicating an azimuth direction of the sensing by proxy responder that is measured by the sensing by proxy initiator; an Elevation subfield, indicating an elevation direction of the sensing by proxy responder that is measured by the sensing by proxy initiator; or a Range subfield, indicating a range of the sensing by proxy responder that is measured by the sensing by proxy initiator.

In some embodiments, the additional fields are carried in the SBP Parameters Control field.

In some embodiments, the second information is carried in the SBP Parameters element corresponding to the second frequency band.

In some embodiments, the SBP Response frame carries third information, wherein the third information carries information for assisting in parsing a sensing report.

In some embodiments, the first receiving module 12 is further configured to receive an SBP Report frame from the sensing by proxy responder. The SBP Report frame carries third information, wherein the third information carries information for assisting in parsing a sensing report.

In some embodiments, the third information indicates at least one of: lists of transmitter beams or receiver beams of N sensing by proxy responders; or operation parameters of the N sensing by proxy responders in a sensing measurement process.

In some embodiments, the lists of transmitter beams or receiver beams of the N sensing by proxy responders are carried in N sensing beam descriptor elements, and each of the N sensing beam descriptor elements carries the list of transmitter beams or receiver beams of one sensing by proxy responder.

In some embodiments, the operation parameters of the N sensing by proxy responders in the sensing measurement process are carried in N Sensing Measurement Setup elements, and each of the N Sensing Measurement Setup elements carries the operation parameters of one sensing by proxy responders in the sensing measurement process.

In some embodiments, the N is set based on the number of the sensing by proxy responders participating in the sensing measurement.

In some embodiments, the SBP Report frame carries fourth information, wherein the fourth information carries the information for assisting in parsing the sensing report.

In some embodiments, the fourth information includes at least one of: a Range subfield; a Doppler subfield; a Transmitter Beam Orientation subfield; or a Receiver Beam Orientation subfield.

In some embodiments, the fourth information is carried in a sensing report element of the second frequency band.

In some embodiments, the first transmitting module 11 is implemented based on a transmitter in a communication device, the first receiving module 12 is implemented based on a receiver in the communication device, and the respective frames may be generated, processed, and parsed based on a processor in the communication device.

FIG. 25 is a structural block diagram of an apparatus for sensing by proxy according to some embodiments of the present disclosure. The apparatus includes: a second receiving module 21 and a second transmitting module 22.

The second receiving module 21 is configured to receive an SBP Request frame from a sensing by proxy initiator, wherein the SBP Request frame is used to request a sensing by proxy responder to perform sensing measurement of a second frequency band in a proxy mode.

The second transmitting module 22 is configured to transmit an SBP Response frame to the sensing by proxy initiator, wherein the SBP Response frame carries third information, the third information carrying information for assisting in parsing a sensing report.

The apparatus for sensing by proxy illustrated in FIG. 25 is applicable to the sensing by proxy responder supporting both the first frequency band and the second frequency band.

In some embodiments, the second transmitting module 22 is configured to transmit an SBP Report frame to the sensing by proxy initiator, wherein the SBP Report frame carries the third information, the third information carrying the information for assisting in parsing the sensing report.

In some embodiments, the third information indicates at least one of: lists of transmitter beams or receiver beams of N sensing by proxy responders; or operation parameters of the N sensing by proxy responders in a sensing measurement process.

In some embodiments, the lists of transmitter beams or receiver beams of the N sensing by proxy responders are carried in N sensing beam descriptor elements, and each of the N sensing beam descriptor elements carries the list of transmitter beams or receiver beams of one sensing by proxy responder.

In some embodiments, the operation parameters of the N sensing by proxy responders in the sensing measurement process are carried in N Sensing Measurement Setup elements, and each of the N Sensing Measurement Setup elements carries the operation parameters of one sensing by proxy responders in the sensing measurement process.

In some embodiments, the N is set based on the number of the sensing by proxy responders participating in the sensing measurement.

In some embodiments, the SBP Report frame carries fourth information, wherein the fourth information carries the information for assisting in parsing the sensing report.

In some embodiments, the fourth information includes at least one of: a Range subfield; a Doppler subfield; a Transmitter Beam Orientation subfield; or a Receiver Beam Orientation subfield.

In some embodiments, the fourth information is carried in a sensing report element of the second frequency band.

Still referring to the structural block diagram of the apparatus for sensing by proxy as illustrated in FIG. 25, the apparatus includes: a second receiving module and a second transmitting module.

The second receiving module is configured to receive an SBP Request frame from the sensing by proxy initiator, wherein the SBP Request frame is used to request the sensing by proxy responder to perform sensing measurement of at least one of a first sensing type or a first sensing range of the second frequency band in a proxy mode.

The second transmitting module is configured to transmit an SBP Response frame to the sensing by proxy initiator.

The sensing by proxy initiator is a device that supports the first frequency band but does not support the second frequency band.

In some embodiments, the SBP Request frame carries first information, wherein the first information indicates the first sensing type. The first sensing type is one of a plurality of sensing types, wherein the plurality of sensing types include monostatic sensing.

In some embodiments, the first information includes at least one of: a Sensing Type field; a Monostatic Sensing field; or at least one subfield of an SBP Parameters element.

In some embodiments, the first information includes the Sensing Type field, and different values of the Sensing Type field correspond to different sensing types.

For example, a corresponding relationship between a value of the Sensing Type field and the first sensing type includes one or more of the following cases. In some embodiments, in the case where the Sensing Type field takes a first value, the first sensing type is coordinated monostatic sensing. In the case where the Sensing Type field takes a second value, the first sensing type is coordinated bistatic sensing. In the case where the Sensing Type field takes a third value, the first sensing type is bistatic sensing. In the case where the Sensing Type field takes a fourth value, the first sensing type is multistatic sensing. In the case where the Sensing Type field takes a fifth value, the first sensing type is the monostatic sensing.

In some embodiments, the first information includes the Monostatic Sensing field. In the case where the Monostatic Sensing field takes the first value, the first sensing type is not the monostatic sensing. In the case where the Monostatic Sensing field takes the second value, the first sensing type is the monostatic sensing.

In some embodiments, the first information further includes the Sensing Type field. In the case that the Monostatic Sensing field takes the first value, the first sensing type is a sensing type indicated by the value of the Sensing Type field.

In some embodiments, the first information includes the Sensing Type field and the at least one subfield of the SBP Parameters element. In the case where the Sensing Type field takes the first value and the at least one subfield of the SBP Parameters element takes a predetermined value corresponding to the subfield, the first sensing type is the monostatic sensing. In the case where the Sensing Type field takes the first value and at least one subfield of the SBP Parameters element does not take the predetermined value corresponding to the subfield, the first sensing type is coordinated monostatic sensing. In the case where the Sensing Type field takes the second value, the first sensing type is coordinated bistatic sensing. In the case where the Sensing Type field takes the third value, the first sensing type is bistatic sensing. In the case where the Sensing Type field takes the fourth value, the first sensing type is multistatic sensing.

In some embodiments, the Sensing Type field is carried in a Sensing Measurement Setup element corresponding to the second frequency band; and the Sensing Measurement Setup element indicates operation parameters of the sensing measurement process. The monostatic Sensing Type field is carried in an SBP Parameters element corresponding to the second frequency band; and the SBP Parameters element indicates the operation parameters of the sensing measurement process. The at least one subfield of the SBP Parameters element is carried in the SBP Parameters element corresponding to the second frequency band.

In some embodiments, the Sensing Type field is carried in a Sensing Measurement Setup Control field in the Sensing Measurement Setup element corresponding to the second frequency band. The monostatic Sensing Type field is carried in an SBP Parameters Control field in the SBP Parameters element corresponding to the second frequency band. The at least one subfield of the SBP Parameters element is carried in the SBP Parameters Control field in the SBP Parameters element corresponding to the second frequency band.

In some embodiments, the SBP Request frame carries second information, wherein the second information indicates the first sensing range.

In some embodiments, the second information includes at least one of: a Target Orientation field, indicating location information of a target relative to the sensing by proxy initiator; an LCI field, indicating location information of the sensing by proxy initiator; or a Peer Orientation field, indicating location information of the sensing by proxy responder that is measured by the sensing by proxy initiator.

In some embodiments, the second information further includes at least one of the following additional fields: a Target Orientation Present field, indicating whether the Target Orientation field is present; an LCI Present field, indicating whether the LCI field is present; or a Peer Orientation Present field, indicating whether the Peer Orientation field is present.

In some embodiments, in the case where the Target Orientation Present field takes a first value, the Target Orientation field is not present. In the case where the Target Orientation Present field takes a second value, the Target Orientation field is present. In the case where the LCI Present field takes the first value, the LCI field is not present. In the case where the LCI Present field takes the second value, the LCI field is present. In the case where the Peer Orientation Present field takes the first value, the Peer Orientation field is not present. In the case where the Peer Orientation Present field takes the second value, the Peer Orientation field is present.

In some embodiments, the Target Orientation field includes at least one of: a Target Azimuth subfield, indicating an azimuth of the target relative to the sensing by proxy initiator; an Azimuth Span subfield, indicating a span size of the azimuth; a Target Elevation subfield, indicating an elevation of the target relative to the sensing by proxy initiator; an Elevation Span subfield, indicating a span size of the elevation; a Target Range subfield, indicating a range of the target relative to the sensing by proxy initiator; or a Range Span subfield, indicating a span size of the range.

In some embodiments, the Peer Orientation field includes at least one of: an Azimuth subfield, indicating an azimuth direction of the sensing by proxy responder that is measured by the sensing by proxy initiator; an Elevation subfield, indicating an elevation direction of the sensing by proxy responder that is measured by the sensing by proxy initiator; or a Range subfield, indicating a range of the sensing by proxy responder that is measured by the sensing by proxy initiator.

In some embodiments, the additional fields are carried in the SBP Parameters Control field.

In some embodiments, the second information is carried in the SBP Parameters element corresponding to the second frequency band.

In some embodiments, the second transmitting module 22 is implemented based on a transmitter in a communication device, the second receiving module 21 is implemented based on a receiver in the communication device, and the respective frames may be generated, processed, and parsed based on a processor in the communication device.

FIG. 26 is a schematic structural diagram of a communication device according to some embodiments of the present disclosure. The communication device may be at least one of an AP, an STA, a sensing by proxy initiator, a sensing by proxy responder, a sensing initiator, a sensing responder, a DMG sensing by proxy initiator, a DMG sensing responder, a DMG sensing initiator, or a DMG sensing responder.

In some embodiments, the communication device 800 includes a processor 801, a receiver 802, a transmitter 803, a memory 804, and a bus 805.

The processor 801 includes one or more processing cores, and the processor 801 executes various functional applications and performs information processing by running software programs and modules.

The processor 801 may implement the processes of the method for sensing by proxy in the above embodiments, such as generating an SBP Request frame, an SBP Response frame, an SBP Report frame, or the like.

The receiver 802 and the transmitter 803 may be implemented as one communication assembly, wherein the communication assembly may be a communication chip.

The receiver 802 may implement each transmitting process of the method for sensing by proxy in the above embodiments, and the transmitter 803 may implement each receiving process of the method for sensing by proxy in the above embodiments.

The memory 804 is connected to the processor 801 over the bus 805. The memory 804 is configured to store at least one executable instruction, and the processor 801 is configured to execute the at least one executable instruction to perform the processes in the above method embodiments.

In addition, the memory 804 may be implemented by any type or combination of volatile or non-volatile storage devices including, but not limited to: a magnetic or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

Those skilled in the art should understand that the structure illustrated in FIG. 26 does not limit the communication device 800, and the communication device may include more or fewer components than those illustrated, or some of the components may be combined, or a different arrangement of components may be employed.

In some embodiments, the embodiments of the present disclosure further provide a computer-readable storage medium. The computer-readable storage medium stores one or more executable instructions. The one or more executable instructions, when loaded and executed by a processor, cause a communication device to perform the method for sensing by proxy as described above.

In some embodiments, the embodiments of the present disclosure further provide a chip. The chip includes one or more programmable logic circuits or one or more programs. The chip is configured to, based on the one or more programmable logic circuits or the one or more programs, cause a communication device to perform the method for sensing by proxy as described above.

In some embodiments, the embodiments of the present disclosure further provide a computer program product. The computer program product includes one or more computer instructions stored in a computer-readable storage medium. The one or more computer instructions, when read by a processor of a communication device from the computer-readable storage medium and executed by the processor, cause the communication device to perform the method for sensing by proxy as described above.

Those skilled in the art should recognize that in the one or more examples described above, the functions described in the embodiments of the present disclosure may be implemented using hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, wherein the communication medium includes any medium that facilitates the transfer of a computer program from one place to another. The storage medium is any available medium that is accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely optional embodiments of the present disclosure and are not intended to limit the present disclosure. Any modifications, equivalent substitutions, improvements, and the like, made within the spirit and principle of the present disclosure should fall within the protection scope of the present disclosure.

1. A communication device, wherein the communication device is a sensing by proxy initiator supporting a first frequency band, the communication device comprising:
a processor; and
a memory, configured to store one or more executable instructions of the processor,
wherein the processor is configured to load the one or more executable instructions to cause the communication device to:
transmit a Sensing by Proxy (SBP) Request frame to a sensing by proxy responder, wherein the SBP Request frame is used to request the sensing by proxy responder to perform sensing measurement of a second frequency band in a proxy mode and indicate at least one of a first sensing type or a first sensing range to the sensing by proxy responder; and
receive an SBP Response frame from the sensing by proxy responder,
wherein the sensing by proxy responder is a device that supports both the first frequency band and the second frequency band.

2. The communication device according to claim 1, wherein the SBP Request frame carries first information, wherein the first information indicates the first sensing type, the first sensing type being one of a plurality of sensing types, the plurality of sensing types comprising monostatic sensing; and the first information comprises at least one of:
a Sensing Type field;
a Monostatic Sensing field; or
at least one subfield of an SBP Parameters element.

3. The communication device according to claim 2, wherein
a Sensing Type field is carried in a Sensing Measurement Setup element corresponding to the second frequency band, wherein the Sensing Measurement Setup element indicates operation parameters of a sensing measurement process;
a Monostatic Sensing Type field is carried in an SBP Parameters element corresponding to the second frequency band, wherein the SBP Parameters element indicates operation parameters of a sensing measurement process; and
at least one subfield of an SBP Parameters element is carried in an SBP Parameters element corresponding to the second frequency band.

4. The communication device according to claim 1, wherein the SBP Request frame carries second information, wherein the second information indicates the first sensing range, and the second information comprises at least one of:
a Target Orientation field, indicating location information (LCI) of a target relative to the sensing by proxy initiator;
an LCI field, indicating location information of the sensing by proxy initiator; or
a Peer Orientation field, indicating location information of the sensing by proxy responder that is measured by the sensing by proxy initiator.

5. The communication device according to claim 4, wherein the second information further comprises at least one of the following additional fields:
a Target Orientation Present field, indicating whether the Target Orientation field is present;
an LCI Present field, indicating whether the LCI field is present; or
a Peer Orientation Present field, indicating whether the Peer Orientation field is present.

6. The communication device according to claim 4, wherein the Target Orientation field comprises at least one of:
a Target Azimuth subfield, indicating an azimuth of the target relative to the sensing by proxy initiator;
an Azimuth Span subfield, indicating a span size of the azimuth;
a Target Elevation subfield, indicating an elevation of the target relative to the sensing by proxy initiator;
an Elevation Span subfield, indicating a span size of the elevation;
a Target Range subfield, indicating a range of the target relative to the sensing by proxy initiator; or
a Range Span subfield, indicating a span size of the range; and
the Peer Orientation field comprises at least one of:
an Azimuth subfield, indicating an azimuth direction of the sensing by proxy responder that is measured by the sensing by proxy initiator;
an Elevation subfield, indicating an elevation direction of the sensing by proxy responder that is measured by the sensing by proxy initiator; or
a Range subfield, indicating a range of the sensing by proxy responder that is measured by the sensing by proxy initiator.

7. The communication device according to claim 5, wherein the additional fields are carried in an SBP Parameters Control field.

8. The communication device according to claim 4, wherein the second information is carried in an SBP Parameters element corresponding to the second frequency band.

9. The communication device according to claim 1, wherein the SBP Response frame carries third information, wherein the third information carries information for assisting in parsing a sensing report; or
the processor is configured to load the one or more executable instructions to further cause the communication device to:
receive an SBP Report frame from the sensing by proxy responder, wherein the SBP Report frame carries third information, the third information carrying information for assisting in parsing a sensing report.

10. The communication device according to claim 9, wherein the third information indicates at least one of:
lists of transmitter beams or receiver beams of N sensing by proxy responders; or
operation parameters of N sensing by proxy responders in a sensing measurement process;
wherein the N is set based on a number of the sensing by proxy responders participating in the sensing measurement.

11. The communication device according to claim 10, wherein the lists of transmitter beams or receiver beams of the N sensing by proxy responders are carried in N Sensing Beam Descriptor elements, and each of the N Sensing Beam Descriptor elements carries the list of transmitter beams or receiver beams of one sensing by proxy responder; or
the operation parameters of the N sensing by proxy responders in the sensing measurement process are carried in N Sensing Measurement Setup elements, and each of the N Sensing Measurement Setup elements carries the operation parameters of one sensing by proxy responders in the sensing measurement process.

12. A communication device, wherein the communication device is a sensing by proxy responder supporting a first frequency band and a second frequency band, the communication device comprising:
a processor; and
a memory, configured to store one or more executable instructions of the processor,
wherein the processor is configured to load the one or more executable instructions to cause the communication device to:
receive a Sensing by Proxy (SBP) Request frame from a sensing by proxy initiator, wherein the SBP Request frame is used to request the sensing by proxy responder to perform sensing measurement of the second frequency band in a proxy mode; and
transmit an SBP Response frame to the sensing by proxy initiator, wherein the SBP Response frame carries third information, the third information carrying information for assisting in parsing a sensing report.

13. The communication device according to claim 12, wherein the processor is configured to load the one or more executable instructions to further cause the communication device to:
transmit an SBP Report frame to the sensing by proxy initiator, wherein the SBP Report frame carries the third information, the third information carrying the information for assisting in parsing the sensing report.

14. The communication device according to claim 12, wherein the third information indicates at least one of:
lists of transmitter beams or receiver beams of N sensing by proxy responders; or
operation parameters of N sensing by proxy responders in a sensing measurement process;
wherein the N is set based on a number of the sensing by proxy responders participating in the sensing measurements.

15. The communication device according to claim 13, wherein the SBP Report frame carries fourth information, wherein the fourth information carries the information for assisting in parsing the sensing report, and the fourth information comprises at least one of:
a Range subfield;
a Doppler subfield;
a Transmitter Beam Orientation subfield; or
a Receiver Beam Orientation subfield.

16. A communication device, wherein the communication device is a sensing by proxy responder supporting a first frequency band and a second frequency band, the communication device comprising:
a processor; and
a memory, configured to store one or more executable instructions of the processor,
wherein the processor is configured to load the one or more executable instructions to cause the communication device to:
receive a Sensing by Proxy (SBP) Request frame from a sensing by proxy initiator, wherein the SBP Request frame is used to request the sensing by proxy responder to perform sensing measurement of at least one of a first sensing type or a first sensing range of the second frequency band in a proxy mode; and
transmit an SBP Response frame to the sensing by proxy initiator,
wherein the sensing by proxy initiator is a device that supports the first frequency band but does not support the second frequency band.

17. The communication device according to claim 16, wherein the SBP Request frame carries first information, wherein the first information indicates the first sensing type, the first sensing type being one of a plurality of sensing types, the plurality of sensing types comprising monostatic sensing; and the first information comprises at least one of:
a Sensing Type field;
a Monostatic Sensing field; or
at least one subfield of an SBP Parameters element.

18. The communication device according to claim 17, wherein the first information comprises the Sensing Type field, and different values of the Sensing Type field correspond to different sensing types; and a corresponding relationship between the value of the Sensing Type field and the sensing type includes one or more of the following cases:
in a case where the Sensing Type field takes a first value, the first sensing type is coordinated monostatic sensing;
in a case where the Sensing Type field takes a second value, the first sensing type is coordinated bistatic sensing;
in a case where the Sensing Type field takes a third value, the first sensing type is bistatic sensing;
in a case where the Sensing Type field takes a fourth value, the first sensing type is multistatic sensing; or
in a case where the Sensing Type field takes a fifth value, the first sensing type is the monostatic sensing.

19. The communication device according to claim 17, wherein the first information comprises the Monostatic Sensing field and the Sensing Type field; wherein
in a case where the Monostatic Sensing field takes a first value, the first sensing type is a sensing type indicated by a value of the Sensing Type field but not the monostatic sensing; or
in a case where the Monostatic Sensing field takes a second value, the first sensing type is monostatic sensing.

20. The communication device according to claim 17, wherein the first information comprises the Sensing Type field and the at least one subfield of the SBP Parameters element; a corresponding relationship between a value of the Sensing Type field and the first sensing type includes one or more of the following cases:
in a case where the Sensing Type field takes a first value and the at least one subfield of the SBP Parameters element is a predetermined value corresponding to the subfield, the first sensing type is the monostatic sensing;
in a case where the Sensing Type field takes the first value and the at least one subfield of the SBP Parameters element is not the predetermined value corresponding to the subfield, the first sensing type is coordinated monostatic sensing;
in a case where the Sensing Type field takes a second value, the first sensing type is coordinated bistatic sensing;
in a case where the Sensing Type field takes a third value, the first sensing type is bistatic sensing; or
in a case that the Sensing Type field takes a fourth value, the first sensing type is multistatic sensing.
